(19) United States
(12) Patent Application Publication
(10) Pub. No.: US 2019/0292986 A1
(43) Pub. Date: Sep. 26, 2019

(54) GAS TURBINE SYSTEM

(71) Applicant: Panasonic Intellectual Property Management Co., Ltd., Osaka (JP)

(72) Inventors: MASAYA HONMA, Hyogo (JP); HIDETOSHI TAGUCHI, Osaka (JP)

(21) Appl. No.: 16/286,543

(22) Filed: Feb. 26, 2019

(30) Foreign Application Priority Data
Mar. 20, 2018 (JP) 2018-051885
Jan. 22, 2019 (JP) 2019-008472

(51) Int. Cl. F02C 7/18; F02C 3/22; F02C 6/08; F02C 7/224

(52) U.S. Cl. CPC F02C 7/185; F02C 3/22; F05D 2220/32; F02C 7/224; F05D 2260/213; F02C 6/08

(57) ABSTRACT

A gas turbine apparatus includes a first compressor, a combustor, and a first turbine. The first compressor compresses a working fluid. The combustor injects a fuel into the working fluid discharged from the first compressor and combusts the fuel. The first turbine expands combustion gas produced in the combustor. A bleeding cycle apparatus includes a second compressor and an expansion mechanism. The second compressor compresses the working fluid, extracted from the gas turbine apparatus, whose pressure has been raised by the first compressor. The expansion mechanism expands the working fluid discharged from the second compressor. A first heat exchanger performs a heat exchange between the working fluid compressed by the first compressor and to be expanded by the first turbine and the working fluid compressed by the second compressor and to be expanded by the expansion mechanism.

### BACKGROUND

### 1. Technical Field

The present disclosure relates to a gas turbine system.

### 2. Description of the Related Art

There has been known a gas turbine system including a gas turbine apparatus. In one conventional example of a system, high-temperature heat is taken out through utilization of exhaust heat produced when the gas turbine apparatus generates electricity. Meanwhile, a portion of high-pressure air produced in a compressor of the gas turbine apparatus is extracted as bled fluid. The bled fluid is recompressed and then expanded. As a result, low-temperature heat is taken out. Such a system is described, for example, in Japanese Unexamined Patent Application Publication No. 2017-137858.

FIG. 35 is a schematic view of a gas turbine system described in Japanese Unexamined Patent Application Publication No. 2017-137858. As shown in FIG. 35, the gas turbine system 100a includes a micro-gas turbine apparatus 101a and a bleeding cycle apparatus 102. The micro-gas turbine apparatus 101a includes a first compressor 111, a first turbine 112, a motor generator 113, a regenerative heat exchanger 114, and a combustor 115. The first compressor 111 and the first turbine 112 are coupled to each other by a first shaft 117.

The bleeding cycle apparatus 102 includes a second compressor 121, a heat exchanger 124, a second turbine 122, and a motor 123. The second compressor 121 compresses a working fluid extracted from the micro-gas turbine apparatus 101a. The heat exchanger 124 cools the working fluid with a fuel flowing through a fuel supply route 151. The second turbine 122 expands the working fluid having flowed out from the heat exchanger 124. The second compressor 121 and the second turbine 122 are coupled to each other by a second shaft 127.

Bled fluid extracted from the micro-gas turbine apparatus 101a is cooled by an intercooler 116. Next, the bled fluid has its pressure raised by the second compressor 121 of the bleeding cycle apparatus 102. Next, the bled fluid is cooled by the heat exchanger 124. Next, the bled fluid is expanded by the second turbine 122. As a result, low-temperature heat can be taken out.

### SUMMARY

The technology of Japanese Unexamined Patent Application Publication No. 2017-13785 has room for improvement in efficiency of a gas turbine system. One non-limiting and exemplary embodiment provides a technology suited for improving the efficiency of a gas turbine system.

In one general aspect, the techniques disclosed here feature a gas turbine system including: a gas turbine apparatus including a first compressor that compresses a working fluid, a combustor that injects a fuel into the working fluid discharged from the first compressor and combusts the fuel, and a first turbine that expands combustion gas produced in the combustor; a bleeding cycle apparatus including a second compressor that compresses the working fluid, extracted from the gas turbine apparatus, whose pressure has been raised by the first compressor and an expansion mechanism that expands the working fluid discharged from the second compressor; and a first heat exchanger that performs a heat exchange between the working fluid compressed by the first compressor and to be expanded by the first turbine and the working fluid compressed by the second compressor and to be expanded by the expansion mechanism.

The technology according to the present disclosure is suitable for improving the efficiency of a gas turbine system.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram of a gas turbine system according to a first embodiment;

FIG. 2 is a block diagram of a gas turbine system according to a second embodiment;

FIG. 3 is a block diagram of a gas turbine system according to the second embodiment;

FIG. 4 is a block diagram of a gas turbine system according to a third embodiment;

FIG. 5 is a block diagram of a gas turbine system according to a fourth embodiment;

FIG. 6 is a block diagram of a gas turbine system according to the fourth embodiment;

FIG. 7 is a block diagram of a gas turbine system according to the fourth embodiment;

FIG. 8 is a block diagram of a gas turbine system according to the fourth embodiment;

FIG. 9 is a block diagram of a gas turbine system according to the fourth embodiment;

FIG. 10 is a block diagram of a gas turbine system according to the fourth embodiment;

FIG. 11 is a block diagram of a gas turbine system according to a fifth embodiment;

FIG. 12 is a block diagram of a gas turbine system according to the fifth embodiment;

FIG. 13 is a block diagram of a gas turbine system according to a sixth embodiment;

FIG. 14 is a block diagram of a gas turbine system according to a seventh embodiment;

FIG. 15 is a block diagram of a gas turbine system according to the seventh embodiment;

FIG. 16 is a block diagram of a gas turbine system according to the seventh embodiment;

FIG. 17 is a block diagram of a gas turbine system according to the seventh embodiment;

FIG. 18 is a block diagram of a gas turbine system according to the seventh embodiment;

FIG. 19 is a block diagram of a gas turbine system according to the seventh embodiment;

FIG. 20 is a block diagram of a gas turbine system according to an eighth embodiment;

FIG. 21 is a block diagram of a gas turbine system according to the eighth embodiment;

FIG. 22 is a block diagram of a gas turbine system according to a ninth embodiment;

FIG. 23 is a block diagram of a gas turbine system according to a tenth embodiment;

FIG. 24 is a block diagram of a gas turbine system according to the tenth embodiment;

FIG. 25 is a block diagram of a gas turbine system according to an eleventh embodiment;

FIG. 26 is a block diagram of a gas turbine system according to a twelfth embodiment;

FIG. 27 is a block diagram of a gas turbine system according to the twelfth embodiment;

FIG. 28 is a block diagram of a gas turbine system according to the twelfth embodiment;

FIG. 29 is a block diagram of a gas turbine system according to the twelfth embodiment;

FIG. 30 is a block diagram of a gas turbine system according to the twelfth embodiment;

FIG. 31 is a block diagram of a gas turbine system according to the twelfth embodiment;

FIG. 32 is a block diagram of a gas turbine system according to a thirteenth embodiment;

FIG. 33 is a block diagram of a gas turbine system according to a fourteenth embodiment;

FIG. 34 is a block diagram of a gas turbine system according to a fifteenth embodiment; and

FIG. 35 is a block diagram of a gas turbine system of a conventional technology.

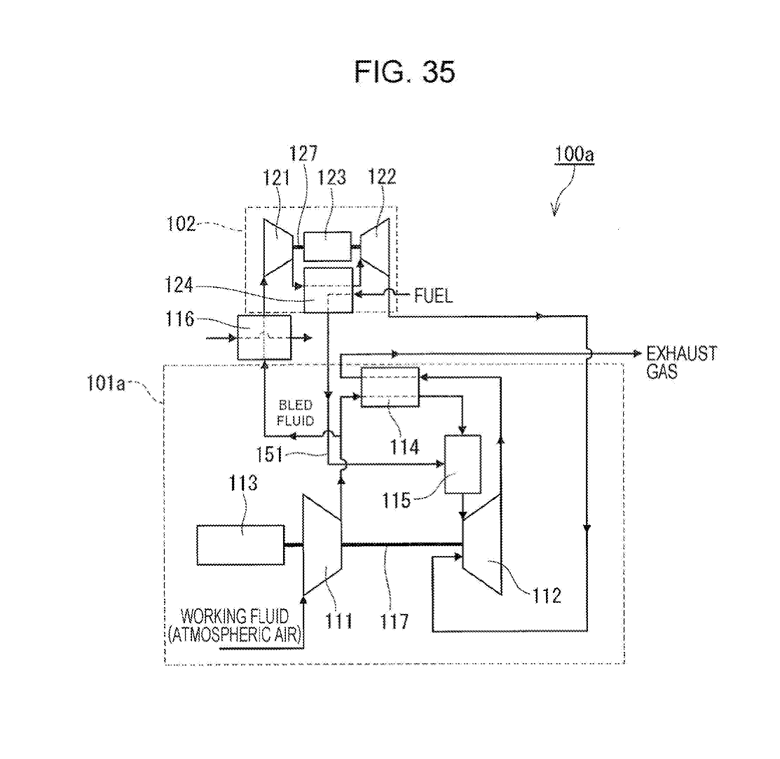

### DETAILED DESCRIPTION

### Brief Overview of an Aspect of the Present Disclosure

In a first aspect of the present disclosure, there is provided a gas turbine system including:

a gas turbine apparatus including a first compressor that compresses a working fluid, a combustor that injects a fuel into the working fluid discharged from the first compressor and combusts the fuel, and a first turbine that expands combustion gas produced in the combustor;

a bleeding cycle apparatus including a second compressor that compresses the working fluid, extracted from the gas turbine apparatus, whose pressure has been raised by the first compressor and an expansion mechanism that expands the working fluid discharged from the second compressor; and

a first heat exchanger that performs a heat exchange between the working fluid compressed by the first compressor and to be expanded by the first turbine and the working fluid compressed by the second compressor and to be expanded by the expansion mechanism.

The technology according to the first aspect is suitable for improving the efficiency of the gas turbine system.

A second aspect of the present disclosure may be directed, for example, to the gas turbine system according to the first aspect, further including a second heat exchanger that performs a heat exchange between the working fluid compressed by the second compressor and to flow into the first heat exchanger and the fuel.

The second heat exchanger of the second aspect may contribute to improvement in efficiency of the gas turbine system.

A third aspect of the present disclosure may be directed, for example, to the gas turbine system according to the first aspect, further including a second heat exchanger that performs a heat exchange between the working fluid having flowed out from the first heat exchanger and to be expanded by the expansion mechanism and the fuel.

The second heat exchanger of the third aspect may contribute to improvement in efficiency of the gas turbine system.

A fourth aspect of the present disclosure may be directed, for example, to the gas turbine system according to any one of the first to third aspects, wherein the second compressor compresses the working fluid extracted from a connecting point in the gas turbine apparatus after having had its pressure raised by the first compressor,

the gas turbine system further including a third heat exchanger that performs a heat exchange between the working fluid extracted from the connecting point and to be compressed by the second compressor and the fuel.

The third heat exchanger of the fourth aspect may contribute to improvement in efficiency of the gas turbine system.

A fifth aspect of the present disclosure may be directed, for example, to the gas turbine system according to any one of the first to fourth aspects, further including a second heat exchanger that performs a heat exchange between the working fluid compressed by the second compressor and to be expanded by the expansion mechanism and the fuel,

wherein the second compressor compresses the working fluid extracted from a connecting point in the gas turbine apparatus after having had its pressure raised by the first compressor,

the gas turbine system further including a third heat exchanger that performs a heat exchange between the working fluid extracted from the connecting point and to be compressed by the second compressor and the fuel,

wherein the fuel passes through the second heat exchanger first and then passes through the third heat exchanger.

The second and third heat exchangers of the fifth aspect may contribute to improvement in efficiency of the gas turbine system.

A sixth aspect of the present disclosure may be directed, for example, to the gas turbine system according to any one of the first to fourth aspects, further including a second heat exchanger that performs a heat exchange between the working fluid compressed by the second compressor and to be expanded by the expansion mechanism and the fuel,

wherein the second compressor compresses the working fluid extracted from a connecting point in the gas turbine apparatus after having had its pressure raised by the first compressor,

the gas turbine system further including a third heat exchanger that performs a heat exchange between the working fluid extracted from the connecting point and to be compressed by the second compressor and the fuel,

wherein the fuel passes through the third heat exchanger first and then passes through the second heat exchanger.

The second and third heat exchangers of the sixth aspect may contribute to improvement in efficiency of the gas turbine system.

A seventh aspect of the present disclosure may be directed, for example, to the gas turbine system according to the first or four aspect, further including a fourth heat exchanger that performs a heat exchange between the working fluid having flowed out from the first heat exchanger and to be expanded by the expansion mechanism and the working fluid discharged from the expansion mechanism.

The fourth heat exchanger of the seventh aspect may contribute to improvement in efficiency of the gas turbine system.

An eighth aspect of the present disclosure may be directed, for example, to the gas turbine system according to any one of the first to third and seventh aspects, wherein the second compressor compresses the working fluid extracted from a connecting point in the gas turbine apparatus after having had its pressure raised by the first compressor,

the gas turbine system further including a fifth heat exchanger that performs a heat exchange between the working fluid extracted from the connecting point and to be compressed by the second compressor and the working fluid discharged from the expansion mechanism.

The fifth heat exchanger of the eighth aspect may contribute to improvement in efficiency of the gas turbine system.

A ninth aspect of the present disclosure may be directed, for example, to the gas turbine system according to any one of the first, seventh, and eighth aspects, further including a fourth heat exchanger that performs a heat exchange between the working fluid having flowed out from the first heat exchanger and to be expanded by the expansion mechanism and the working fluid discharged from the expansion mechanism,

wherein the second compressor compresses the working fluid extracted from a connecting point in the gas turbine apparatus after having had its pressure raised by the first compressor,

the gas turbine system further including a fifth heat exchanger that performs a heat exchange between the working fluid extracted from the connecting point and to be compressed by the second compressor and the working fluid discharged from the expansion mechanism,

wherein the working fluid discharged from the expansion mechanism passes through the fourth heat exchanger first and then passes through the fifth heat exchanger.

The fourth and fifth heat exchangers of the ninth aspect may contribute to improvement in efficiency of the gas turbine system.

A tenth aspect of the present disclosure may be directed, for example, to the gas turbine system according to any one of the first, seventh, and eighth aspects, further including a fourth heat exchanger that performs a heat exchange between the working fluid having flowed out from the first heat exchanger and to be expanded by the expansion mechanism and the working fluid discharged from the expansion mechanism,

wherein the second compressor compresses the working fluid extracted from a connecting point in the gas turbine apparatus after having had its pressure raised by the first compressor,

the gas turbine system further including a fifth heat exchanger that performs a heat exchange between the working fluid extracted from the connecting point and to be compressed by the second compressor and the working fluid discharged from the expansion mechanism,

wherein the working fluid discharged from the expansion mechanism passes through the fifth heat exchanger first and then passes through the fourth heat exchanger.

The fourth and fifth heat exchangers of the tenth aspect may contribute to improvement in efficiency of the gas turbine system.

An eleventh aspect of the present disclosure may be directed, for example, to the gas turbine system according to any one of the first, fourth, and eighth aspects, further including a cooled room that is supplied with the working fluid discharged from the expansion mechanism,

wherein a path that guides the working fluid from the first heat exchanger into the expansion mechanism passes through the cooled room.

The cooled room of the eleventh aspect may contribute to improvement in efficiency of the gas turbine system.

A twelfth aspect of the present disclosure may be directed, for example, to the gas turbine system according to any one of the first to third, seventh, and eleventh aspects, wherein the second compressor compresses the working fluid extracted from a connecting point in the gas turbine apparatus after having had its pressure raised by the first compressor,

the gas turbine system further including a cooled room that is supplied with the working fluid discharged from the expansion mechanism,

wherein a path that guides the working fluid from the connecting point into the second compressor passes through the cooled room.

The cooled room of the twelfth aspect may contribute to improvement in efficiency of the gas turbine system.

A thirteenth aspect of the present disclosure may be directed, for example, to the gas turbine system according to any one of the first to twelfth aspects, further including a regenerative heat exchanger that performs a heat exchange between the combustion gas discharged from the first turbine and the working fluid having flowed out from the first heat exchanger and to flow into the combustor.

The regenerative heat exchanger of the thirteenth aspect may contribute to improvement in efficiency of the gas turbine system.

A fourteenth aspect of the present disclosure may be directed, for example, to the gas turbine system according to any one of the first to thirteenth aspects, further including an introduction pipe through which the working fluid discharged from the expansion mechanism is introduced into the first turbine.

The introduction pipe of the fourteenth aspect may contribute to improvement in efficiency of the gas turbine system.

In a fifteenth aspect of the present disclosure, there is provided a gas turbine system including:

a gas turbine apparatus including a first compressor that compresses a working fluid, a combustor that injects a fuel into the working fluid discharged from the first compressor and combusts the fuel, and a first turbine that expands combustion gas produced in the combustor;

a bleeding cycle apparatus including a second compressor that compresses the working fluid, extracted from a connecting point in the gas turbine apparatus, whose pressure has been raised by the first compressor and an expansion mechanism that expands the working fluid discharged from the second compressor;

a second heat exchanger that performs a heat exchange between the working fluid having flowed out from the second compressor and to be expanded by the expansion mechanism and the fuel; and

a third heat exchanger that performs a heat exchange between the working fluid extracted from the connecting point and to be compressed by the second compressor and the fuel,

wherein the fuel

(i) passes through the second heat exchanger first and then passes through the third heat exchanger, or

(ii) passes through the third heat exchanger first and then passes through the second heat exchanger.

The technology according to the fifteenth aspect is suitable for improving the efficiency of the gas turbine system.

The technologies of the first to fourteenth aspects are applicable to the fifteenth embodiment. The technology of the fifteenth embodiment is applicable to the first to fourteenth aspects.

Embodiments of the present disclosure are described with reference to the drawings. It should be noted that these embodiments are not intended to limit the present disclosure.

In the embodiments, the expression “efficiency of a gas turbine system” is sometimes used. The efficiency of a gas turbine system is the ratio We/Ei of effective work We done by the gas turbine system to input energy Ei to the gas turbine system. Note here that the input energy Ei may include, for example, the reduced quantity of energy of a fuel inputted into a combustor in the gas turbine system, electric power inputted into equipment such as a pump in the gas turbine system, and the like. The effective work We may include, for example, electric power generated by the gas turbine system, energy involved in the generation of high-temperature heat, energy involved in the generation of low-temperature heat, and the like.

The following description differentiates between heat exchangers by assigning ordinal numbers to them. However, this differentiation is merely for convenience. For example, the first heat exchanger 14 to be described below may be referred to as “inter-cycle heat exchanger”. The second heat exchanger 28 may be referred to as “compressed bled fluid-fuel heat exchanger”. The third heat exchanger 38 may be referred to as “uncompressed bled fluid-fuel heat exchanger”. The fourth heat exchanger 48 may be referred to as “compressed bled fluid-low-temperature heat heat exchanger”. The fifth heat exchanger 58 may be referred to as “uncompressed bled fluid-low-temperature heat heat exchanger”. The sixth heat exchanger 68 may be referred to as “compressed bled fluid-air heat exchanger”. The seventh heat exchanger 78 may be referred to as “uncompressed bled fluid-air heat exchanger”.

### First Embodiment

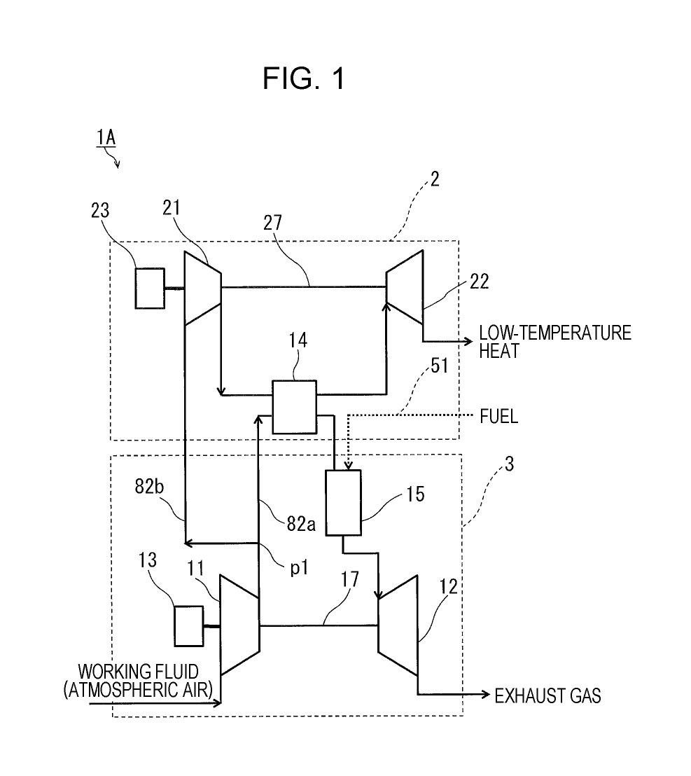

FIG. 1 is a block diagram of a gas turbine system 1A according to a first embodiment of the present disclosure.

As shown in FIG. 1, the gas turbine system 1A includes a gas turbine apparatus 3, a bleeding cycle apparatus 2, and a first heat exchanger 14.

In the first embodiment, air is supplied as a working fluid to the gas turbine apparatus 3 and the bleeding cycle apparatus 2. Another example of these working fluids is an alternative CFC.

Exhaust heat from the gas turbine apparatus 3 can be utilized as high-temperature heat. Meanwhile, the bleeding cycle apparatus 2 cools the working fluid to produce low-temperature heat. For example, the low-temperature heat can be used to constitute a cold atmosphere. Placing an object in the cold atmosphere can cool the object. In one specific example, the working fluid thus cooled itself constitutes a cold atmosphere. This makes it unnecessary to use a medium that is different in type from the working fluid. This also makes it easy to prevent frosting in a case where the cold atmosphere is utilized for a freezing warehouse or the like. Note, however, that the low-temperature heat of the working fluid thus cooled may be supplied to a medium that is different in type from the working fluid and the medium thus cooled may be used to constitute a cold atmosphere. Further, the cold atmosphere can also be utilized for other uses such as refrigeration and cooling as well as freezing. In any specific example, the atmosphere may be composed of air, or may be composed of another type of fluid.

The gas turbine apparatus 3 includes a first compressor 11, a first shaft 17, a first turbine 12, a combustor 15, and a motor generator 13.

The bleeding cycle apparatus 2 includes a second compressor 21, a second shaft 27, an expansion mechanism 22, and a motor generator 23.

The following describes each of these elements of the gas turbine system 1A.

The first compressor 11 compresses a working fluid. An example of the first compressor 11 is a turbo compressor such as a centrifugal compressor.

The combustor 15 injects a fuel into the working fluid discharged from the first compressor 11 and combusts the fuel.

Examples of the fuel that is combusted by the combustor 15 include a liquid fuel and a gaseous fuel. Examples of the liquid fuel include liquefied natural gas (LNG), gasoline, diesel oil, alcohol fuels such as methanol and ethanol. The liquid fuel may be an alcoholic blended fuel containing an alcohol fuel. Examples of the gaseous fuel include city gas, compressed natural gas (CNG), propane (LPG), and hydrogen.

An advantage of using the liquid fuel is that the capacity of a fuel tank (not illustrated) can be reduced. An advantage of using the gaseous fuel is that a mechanism for injecting the fuel into the combustor 15 or other mechanisms can be simplified.

The first turbine 12 expands combustion gas produced in the combustor 15. In the first embodiment, the combustion gas is considered as a form of the working fluid. In other words, the working fluid is considered as a concept that encompasses the combustion gas.

The first shaft 17 couples the first compressor 11 and the first turbine 12 to each other. Specifically, the first shaft 17 couples the first compressor 11, the first turbine 12, and the motor generator 13 to one another.

In the first embodiment, the motor generator 13 functions both as a generator and a motor. For example, the motor generator 13 is used as a motor at the time of activation of the first compressor 11. Specifically, the motor generator 13 can activate the first compressor 11 by rotating the first shaft 17.

The second compressor 21 compresses the working fluid, extracted from the gas turbine apparatus 3, whose pressure has been raised by the first compressor 21. An example of the second compressor 21 is a turbo compressor such as a centrifugal compressor.

The expansion mechanism 22 expands the working fluid discharged from the second compressor 21. An example of the expansion mechanism 22 is an expansion valve, a voluminal expansion machine, a velocity expansion machine such as a turbine, or the like. In the first embodiment, the expansion mechanism 22 is a turbine. In a case where a turbine is used as the expansion mechanism 22, the turbine may be referred to as “second turbine”.

The second shaft 27 couples the second compressor 21 and the expansion mechanism 22 to each other. Specifically, the second shaft 27 coupes the second compressor 21, the expansion mechanism 22, and the motor generator 23 to one another.

In the first embodiment, the motor generator 23 functions both as a generator and a motor. For example, the motor generator 23 is used as a motor at the time of activation of the second compressor 21. Specifically, the motor generator 23 can activate the second compressor 21 by rotating the second shaft 27.

Using the motor generator 23 as a motor can increase the compression ratio of the second compressor 21 and can therefore increase the difference in temperature between the temperature of the working fluid on a suction side of the second compressor 21 and the temperature of the working fluid that is discharged from the expansion mechanism 22. Meanwhile, causing the motor generator 23 to function as a generator can give electric power through the difference between torque that is produced by the expansion mechanism 22 and torque that is used in the second compressor 21.

The first heat exchanger 14 performs a heat exchange between the working fluid compressed by the first compressor 11 and to be expanded by the first turbine 12 and the working fluid compressed by the second compressor 21 and to be expanded by the expansion mechanism 22. Specifically, the first heat exchanger 14 performs a heat exchange between the working fluid compressed by the first compressor 11 and to flow into the combustor 15 and the working fluid compressed by the second compressor 21 and to be expanded by the expansion mechanism 22. An example of the first heat exchanger 14 is a plate heat exchanger. Another example of the first heat exchanger 14 is a plate tube heat exchanger, a fin tube heat exchanger, or the like.

It is possible to omit some of the constituent elements of the gas turbine system 1A. For example, it is possible to omit the first shaft 17 to separate the first compressor 11 and the first turbine 12 from each other. It is also possible to omit the second shaft 27 to separate the second compressor 21 and the expansion mechanism 22 from each other. Further, it is also possible to provide a motor instead of the motor generator 13 and provide a motor instead of the motor generator 23.

The gas turbine system 1A is provided with a first path 82a and a second path 82b. The gas turbine apparatus 3 includes a connecting point p1. The first path 82a guides, toward the combustor 15 and the first turbine 12, the working fluid whose pressure has been raised by the first compressor 21. The second path 82b extends from the connecting point p1. The second path 82b connects the gas turbine apparatus 3 and the bleeding cycle apparatus 2. The second path 82b is a path through which the working fluid, extracted from the gas turbine apparatus 3, whose pressure has been raised by the first compressor 21 flows. In the first embodiment, the first path 82a is provided with the connecting point p1.

The first path 82a and the second path 82b can be constructed of pipes. The same applies to a fuel supply route 51 and an air duct 85, which will be described later.

The following describes the actions and workings of the gas turbine system 1A thus configured.

In the first embodiment, air in the atmosphere flows as a working fluid into the gas turbine apparatus 3. The first compressor 11 sucks in and compresses this working fluid.

A portion of the working fluid compressed by the first compressor 11 flows into the first heat exchanger 14 via the connecting point p1. The first heat exchanger 14 performs a heat exchange between the working fluid discharged from the first compressor 11 and the working fluid discharged from the second compressor 21. This heat exchange raises the temperature of the working fluid discharged from the first compressor 11.

Next, the working fluid flows into the combustor 15. In the combustor 15, a fuel is injected into the working fluid having flowed in, and the fuel combusts, whereby a high-temperature combustion gas is produced. Thus, in the combustor 15, the working fluid turns into the combustion gas and becomes even hotter.

Next, the working fluid flows into the first turbine 12. In the first turbine 12, the working fluid expands and has its pressure reduced to about atmospheric pressure.

The first turbine 12 takes out motive power as rotary torque from the expanding combustion gas to drive the first compressor 11 and supplies surplus electricity to the motor generator 13. Thus, in the motor generator 13, electricity is generated through the use of the output from the first turbine 12.

Exhaust heat from the first turbine 12 can be utilized as high-temperature heat. This high-temperature heat can be utilized in heating, hot-water supply, and the like. Further, it is possible to create a generator based on this high-temperature heat.

A portion of the working fluid discharged from the first compressor 11 passes through the connecting point p1 and flows to the combustor 15 through the first path 82a as mentioned above. Another portion of the working fluid discharged from the first compressor 11 branches at the connecting point p 1 and flows into the second path 82b.

The working fluid having flowed into the second path 82b from the connecting point p1 flows into the bleeding cycle apparatus 2. The working fluid thus flowing into the bleeding cycle apparatus 2 may be referred to as “bled fluid”.

The working fluid having flowed into the bleeding cycle apparatus 2 flows into the second compressor 21. The second compressor 21 sucks in and compresses this working fluid.

Next, the working fluid flows into the first heat exchanger 14. The first heat exchanger 14 performs a heat exchange between the working fluid discharged from the first compressor 11 and the working fluid discharged from the second compressor 21. This heat exchange lowers the temperature of the working fluid discharged from the second compressor 21.

Next, the working fluid flows into the expansion mechanism 22. In the expansion mechanism 22, the working fluid expands and has its pressure reduced to about atmospheric pressure. This expansion further lowers the temperature of the working fluid.

The working fluid thus having its temperature lowered is discharged from the expansion mechanism 22. The temperature of the working fluid that is discharged from the expansion mechanism 22 is a temperature ranging from −100° C. to 10° C. In one specific example, the temperature of the working fluid that is discharged from the expansion mechanism 22 is a temperature ranging from −70° C. to −50° C.

The expansion mechanism 22 takes out motive power as rotary torque from the expanding working fluid to drive the second compressor 21 and supplies surplus electricity to the motor generator 23. Thus, in the motor generator 23, electricity is generated through the use of the output from the expansion mechanism 22.

As mentioned above, in the first embodiment, the first heat exchanger 14 performs a heat exchange between the working fluid discharged from the first compressor 11 and the working fluid discharged from the second compressor 21. This heat exchange raises the temperature of the working fluid discharged from the first compressor 11 and lowers the temperature of the working fluid discharged from the second compressor 21. This heat exchange contributes to improvement in efficiency of the gas turbine system 1A.

Suppose, for example, that the gas turbine system 1A operates to lower the temperature of the working fluid flowing into the expansion mechanism 22 to a predetermined value. In that case, the contribution of the heat exchange performed by the first heat exchanger 14 allows the gas turbine system 1A to give the working fluid at the predetermined value of temperature while operating with high efficiency.

Further, suppose, for example, that the gas turbine system 1A operates to set the temperature of the working fluid flowing into the first turbine 12 to a predetermined value. In that case, the contribution of the heat exchange performed by the first heat exchanger 14 makes it possible to obtain the working fluid at the predetermined value of temperature while reducing the amount of the fuel that is supplied to the combustor 15. This contributes to improvement in efficiency of the gas turbine system 1A.

Incidentally, the intercooler 116 of Japanese Unexamined Patent Application Publication No. 2017-137858 cools a working fluid extracted as bled fluid from the micro-gas turbine apparatus 101a. Japanese Unexamined Patent Application Publication No. 2017-137858 discloses using cooling water to cool the bled fluid. In using cooling water to cool the bled fluid, it is conceivable that the cooling water may be pressure-fed to the intercooler 116 with a pump. However, doing so requires the motive power of the pump, which is not needed in a case where the intercooler 116 is not employed. On the other hand, the first heat exchanger 14 does not require additional motive power for conveyance of a low-temperature heat source outside the gas turbine system 1A. This is advantageous from the point of view of improvement in efficiency of the gas turbine system 1A.

It should be noted that the first embodiment and the embodiments to be described later may be combined with a heat exchanger, such as the intercooler 116, that cools bled fluid with cooling water.

The gas turbine system 1A shown in FIG. 1 may also be described as below with use of the terms “path” and “supply route”.

The gas turbine system 1A is provided with the first path 82a through which the working fluid flows. The first path 82a connects the first compressor 11, the connecting point p1, the first heat exchanger 14, the combustor 15, and the first turbine 12 in this order.

The gas turbine system 1A is provided with the second path 82b through which the working fluid flows. The second path 82b connects the connecting point p1, the second compressor 21, the first heat exchanger 14, and the expansion mechanism 22 in this order.

The gas turbine system 1A is provided with the fuel supply route 51 through which the fuel flows. The fuel supply route 51 connects the fuel tank (not illustrated) and the combustor 15.

The following describes some other embodiments. The following assigns the same reference signs to elements that are common between the embodiment already described and the embodiments to be described thereafter and may omit to describe those elements. Descriptions of the embodiments are mutually applicable unless a technical contradiction arises. The embodiments may be mutually combinable unless a technical contradiction arises.

### Second Embodiment

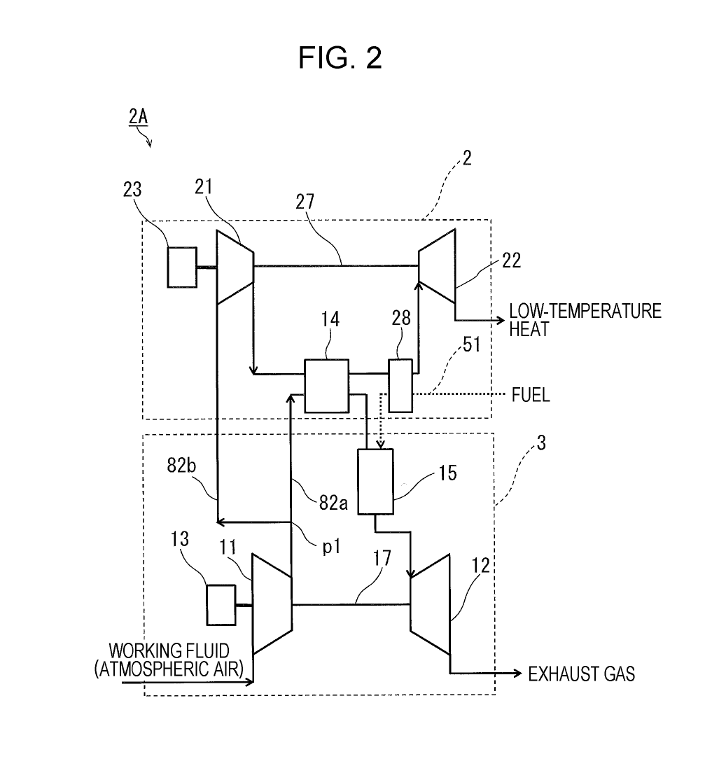

FIG. 2 is a block diagram of a gas turbine system 2A according to a second embodiment.

As shown in FIG. 2, the gas turbine system 2A includes a second heat exchanger 28. The second heat exchanger 28 is provided between the second compressor 21 and the expansion mechanism 22. Specifically, the second heat exchanger 28 is provided between the first heat exchanger 14 and the expansion mechanism 22.

The second heat exchanger 28 performs a heat exchange between the working fluid having flowed out from the second compressor 21 and to be expanded by the expansion mechanism 22 and the fuel. Specifically, the second heat exchanger 28 performs a heat exchange between the working fluid having flowed out from the first heat exchanger 14 and to be expanded by the expansion mechanism 22 and the fuel. An example of the second heat exchanger 28 is a fin tube heat exchanger. Another example of the second heat exchanger 28 is a plate tube heat exchanger, a plate heat exchanger, or the like.

As mentioned above, in the second embodiment, the second heat exchanger 28 performs a heat exchange between the working fluid having flowed out from the first heat exchanger 14 and the fuel. This heat exchange lowers the temperature of the working fluid having flowed out from the first heat exchanger 14 and raises the temperature of the fuel. This heat exchange contributes to improvement in efficiency of the gas turbine system 2A.

Specifically, according to the second embodiment, the temperature of the combustion gas that is supplied from the combustor 15 to the first turbine 12 can be raised by raising the temperature of the fuel in the second heat exchanger 28. This contributes to improvement in thermal efficiency of the first turbine 12, and by extension to improvement in efficiency of the gas turbine system 2A.

Suppose, for example, a case where the ratio of the circulating volume of the working fluid that flows into the combustor 15 from the connecting point p1 to the flow rate of the working fluid that is extracted from the connecting point p1 to the bleeding cycle apparatus 2 is high. In this case, it is not necessarily easy to drastically raise, in the first heat exchanger 14, the temperature of the working fluid that should be guided into the combustor 15. However, in the second embodiment, the second heat exchanger 28, as well as the first heat exchanger 14, contributes to a rise in temperature of the combustion gas that is made to flow out from the combustor 15. This makes it possible to secure the efficiency of the gas turbine system 2A.

Specifically, since the temperature of the fuel that is injected by the combustor 15 can be raised by heating the fuel in the second heat exchanger 28 as well as the first heat exchanger 14, combustion gas whose temperature is sufficiency high can be obtained with a reduction in fuel consumption. This reduction in fuel consumption may contribute to improvement in efficiency of the gas turbine system 2A. In one example, the temperature of the fuel flowing into the second heat exchanger 28 is normal temperature. In the example, the effect of being able to reduce fuel consumption may be effectively exerted.

Further, in the presence of the second heat exchanger 28, the temperature of the working fluid that is discharged from the expansion mechanism 22 can be made lower than in the absence of the second heat exchanger 28.

In one specific example, the heat exchange performed by the second heat exchanger 28 causes the temperature of the working fluid having flowed out from the first heat exchanger 14 to fall from approximately 100° C. to approximately 80° C. This heat exchange causes the temperature of the fuel to rise from 20° C. to approximately 90° C.

The gas turbine system 2A shown in FIG. 2 may also be described as below with use of the terms “path” and “supply route”. In the gas turbine system 2A, the second path 82b connects the connecting point p1, the second compressor 21, the first heat exchanger 14, the second heat exchanger 28, and the expansion mechanism 22 in this order. The fuel supply route 51 connects the fuel tank (not illustrated), the second heat exchanger 28, and the combustor 15 in this order.

The fuel supply route 51 may be provided with a pump for supplying the fuel to the combustor 15. In the second embodiment, the pump may also be utilized to supply the fuel to the second heat exchanger 28. However, unlike the addition of a pump entailed by the employment of the intercooler 116 of Japanese Unexamined Patent Application Publication No. 2017-137858, the utilization of such a pump is merely utilization of an existing pump. For this reason, it is advisable not to suppose that supplying the fuel to the second heat exchanger 28 with the pump provided on the fuel supply route 51 leads to a decrease in efficiency of the gas turbine system 2A. In this respect, the same applies to a case where the fuel is supplied to the after-mentioned third heat exchanger 38 with the pump provided on the fuel supply route 51.

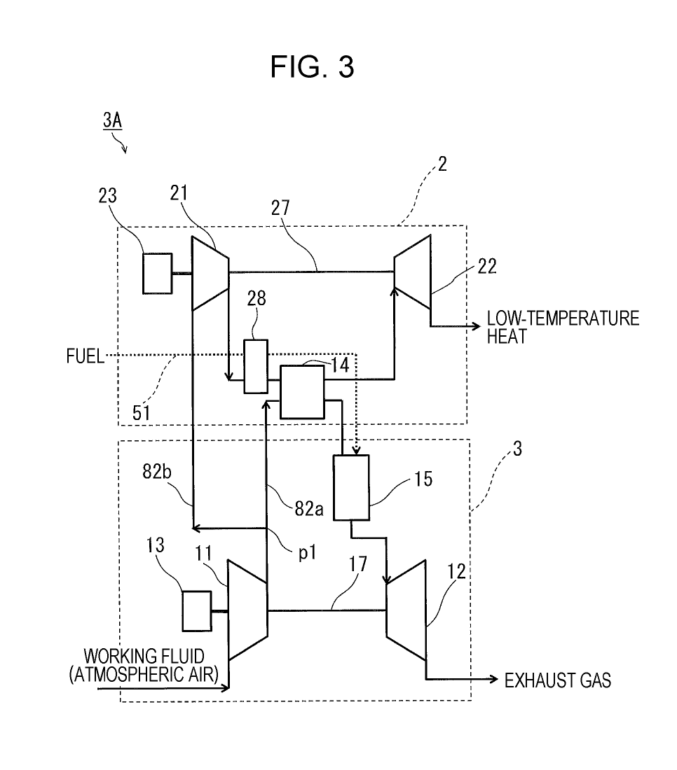

The placement of the second heat exchanger 28 is not limited to that shown in FIG. 2. In a gas turbine system 3A shown in FIG. 3, the second heat exchanger 28 is provided between the second compressor 21 and the first heat exchanger 14. The second heat exchanger 28 performs a heat exchange between the working fluid compressed by the second compressor 21 and to flow into the first heat exchanger 14 and the fuel. In this way, too, the heat exchange performed by the second heat exchanger 28 contributes to improvement in efficiency of the gas turbine system 3A for the same reason as that noted above.

The gas turbine system 3A shown in FIG. 3 may also be described as below with use of the term “path”. In the gas turbine system 3A, the second path 82b connects the connecting point p1, the second compressor 21, the second heat exchanger 28, the first heat exchanger 14, and the expansion mechanism 22 in this order.

The gas turbine system 2A shown in FIG. 2 is more suitable for lowering the temperature of the working fluid in the bleeding cycle apparatus 2 than the gas turbine system 3A shown in FIG. 3.

Meanwhile, the gas turbine system 3A shown in FIG. 3 makes it easier to raise the temperature of the working fluid flowing through the second heat exchanger 28 than the gas turbine system 2A shown in FIG. 2. For this reason, the gas turbine system 3A has an advantage over the gas turbine system 2A from the point of view of raising the temperature of the fuel. Further, suppose a case where the temperature of the fuel is raised by X° C. in the second heat exchanger 28. In this case, the second heat exchanger 28 more easily attains a temperature rise of X° C. with a small heat exchange area in the gas turbine system 3A than in the gas turbine system 2A, as the temperature of the working fluid flowing through the second heat exchanger 28 is higher in the gas turbine system 3A than in the gas turbine system 2A.

### Third Embodiment

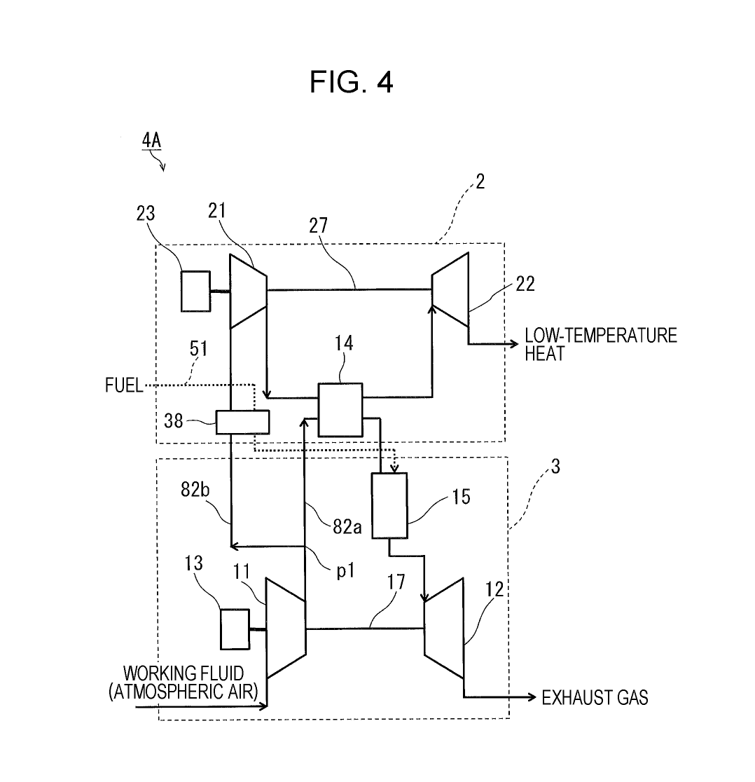

FIG. 4 is a block diagram of a gas turbine system 4A according to a third embodiment.

As shown in FIG. 4, the gas turbine system 4A includes a third heat exchanger 38.

As can be understood from the foregoing description, the second compressor 21 compresses the working fluid extracted from the connecting point p1 in the gas turbine apparatus 3 after having had its pressure raised by the first compressor 11. The third heat exchanger 38 performs a heat exchange between the working fluid extracted from the connecting point p1 and to be compressed by the second compressor 21 and the fuel. An example of the third heat exchanger 38 is a fin tube heat exchanger, a plate tube heat exchanger, a plate heat exchanger, or the like.

The third heat exchanger 38 of the third embodiment contributes to improvement in efficiency of the gas turbine system 4A for the same reason as the second heat exchanger 28 of the second embodiment.

The gas turbine system 4A shown in FIG. 4 may also be described as below with use of the terms “path” and “supply route”. In the gas turbine system 4A, the second path 82b connects the connecting point p1, the third heat exchanger 38, the second compressor 21, the first heat exchanger 14, and the expansion mechanism 22 in this order. The fuel supply route 51 connects the fuel tank (not illustrated), the third heat exchanger 38, and the combustor 15 in this order.

### Fourth Embodiment

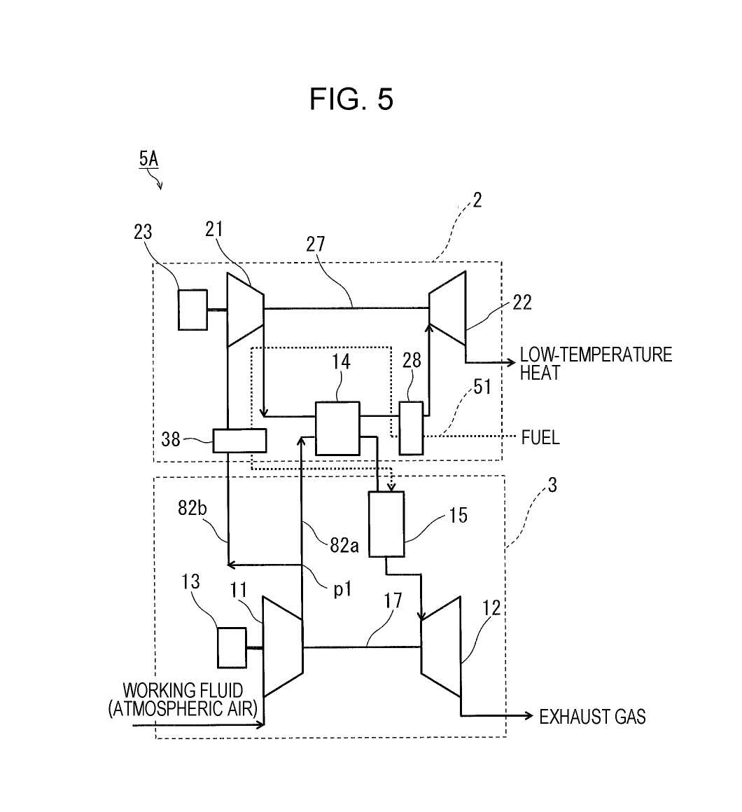

FIG. 5 is a block diagram of a gas turbine system 5A according to a fourth embodiment.

As shown in FIG. 5, the gas turbine system 5A includes the second heat exchanger 28 described with reference to FIG. 2 in the second embodiment and the third heat exchanger 38 described with reference to FIG. 4 in the third embodiment.

In the gas turbine system 5A of FIG. 5, the second heat exchanger 28 performs a heat exchange between the working fluid compressed by the second compressor 21 and to be expanded by the expansion mechanism 22 and the fuel. The third heat exchanger 38 performs a heat exchange between the working fluid extracted from the connecting point p1 and to be compressed by the second compressor 21 and the fuel. The fuel passes through the second heat exchanger 28 first and then passes through the third heat exchanger 38.

Specifically, in the gas turbine system 5A of FIG. 5, the fuel passes through the second heat exchanger 28 first, then passes through the third heat exchanger 38, and then is injected into the working fluid in the combustor 15. Note, however, that the fuel may pass through the second heat exchanger 28 first, then pass through the third heat exchanger 38, and then be returned to the fuel tank.

According to an embodiment in which the fuel is not returned to the fuel tank, a rise in temperature of the fuel in the fuel tank can be avoided. This is suitable for cooling the working fluid in the second heat exchanger 28. Further, the employment of the embodiment in which the fuel is not returned to the fuel tank is suitable for constructing a fuel system in a simple way. Meanwhile, an embodiment in which the fuel is returned to the fuel tank is suitable for raising the temperature of the fuel that is supplied to the combustor 15.

Specifically, as in the example shown in FIG. 2, the second heat exchanger 28 of FIG. 5 performs a heat exchange between the working fluid having flowed out from the first heat exchanger 14 and to be expanded by the expansion mechanism 22 and the fuel.

The gas turbine system 5A shown in FIG. 5 may also be described as below with use of the terms “path” and “supply route”. In the gas turbine system 5A, the second path 82b connects the connecting point p1, the third heat exchanger 38, the second compressor 21, the first heat exchanger 14, the second heat exchanger 28, and the expansion mechanism 22 in this order. The fuel supply route 51 connects the fuel tank (not illustrated), the second heat exchanger 28, the third heat exchanger 38, and the combustor 15 in this order.

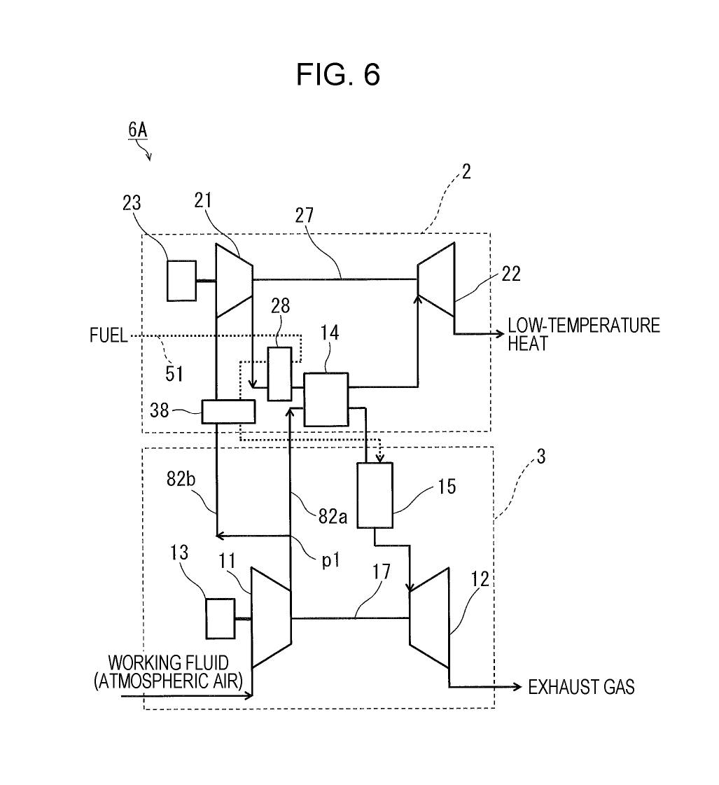

The placement of the second heat exchanger 28 is not limited to that shown in FIG. 5. In a gas turbine system 6A shown in FIG. 6, as in the example shown in FIG. 3, the second heat exchanger 28 performs a heat exchange between the working fluid compressed by the second compressor 21 and to flow into the first heat exchanger 14 and the fuel.

The gas turbine system 6A shown in FIG. 6 may also be described as below with use of the term “path”. In the gas turbine system 6A, the second path 82b connects the connecting point p1, the third heat exchanger 38, the second compressor 21, the second heat exchanger 28, the first heat exchanger 14, and the expansion mechanism 22 in this order. The fuel supply route 51 connects the fuel tank (not illustrated), the second heat exchanger 28, the third heat exchanger 38, and the combustor 15 in this order.

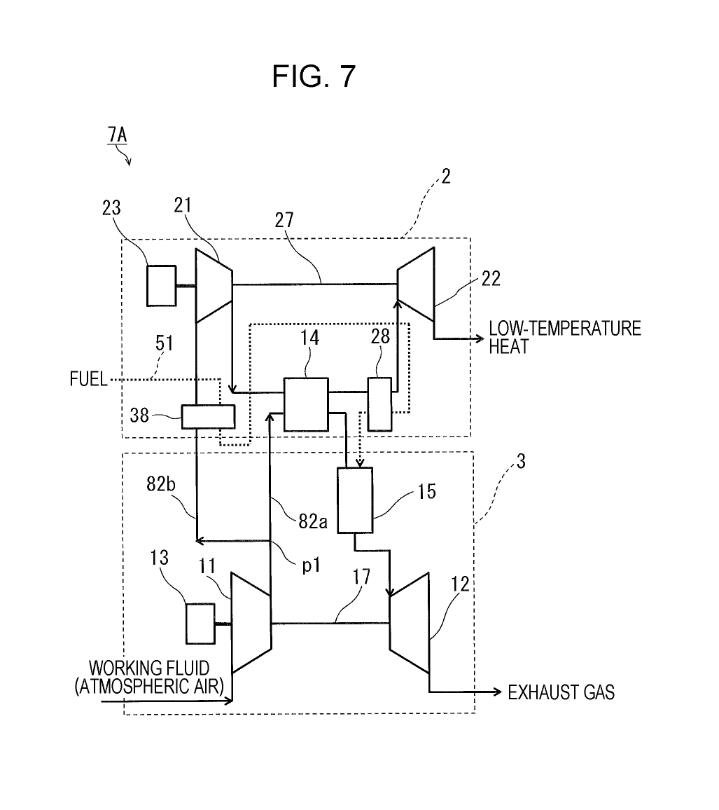

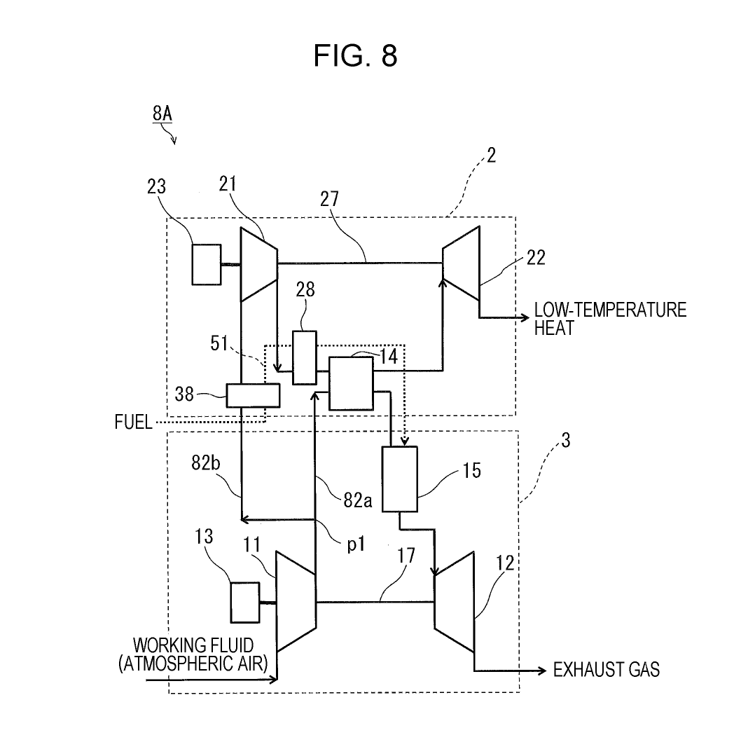

It is also possible to employ examples shown in FIGS. 7 and 8. In a gas turbine system 7A shown in FIG. 7 and a gas turbine system 8A shown in FIG. 8, the fuel passes through the third heat exchanger 38 first and then passes through the second heat exchanger 28.

Specifically, in each of the gas turbine systems 7A and 8A, the fuel passes through the third heat exchanger 38 first, then passes through the second heat exchanger 28, and then is injected into the working fluid in the combustor 15. Note, however, that the fuel may pass through the third heat exchanger 38 first, then pass through the second heat exchanger 28, and then be returned to the fuel tank.

As in the example shown in FIG. 2, the second heat exchanger 28 of FIG. 7 performs a heat exchange between the working fluid having flowed out from the first heat exchanger 14 and to be expanded by the expansion mechanism 22 and the fuel.

The gas turbine system 7A shown in FIG. 7 may also be described as below with use of the terms “path” and “supply route”. In the gas turbine system 7A, the second path 82b connects the connecting point p1, the third heat exchanger 38, the second compressor 21, the first heat exchanger 14, the second heat exchanger 28, and the expansion mechanism 22 in this order. The fuel supply route 51 connects the fuel tank (not illustrated), the third heat exchanger 38, the second heat exchanger 28, and the combustor 15 in this order.

As in the example shown in FIG. 3, the second heat exchanger 28 of FIG. 8 performs a heat exchange between the working fluid compressed by the second compressor 21 and to flow into the first heat exchanger 14 and the fuel.

The gas turbine system 8A shown in FIG. 8 may also be described as below with use of the terms “path” and “supply route”. In the gas turbine system 8A, the second path 82b connects the connecting point p1, the third heat exchanger 38, the second compressor 21, the second heat exchanger 28, the first heat exchanger 14, and the expansion mechanism 22 in this order. The fuel supply route 51 connects the fuel tank (not illustrated), the third heat exchanger 38, the second heat exchanger 28, and the combustor 15 in this order.

The respective gas turbine systems 5A to 8A of FIGS. 5 to 8 attain high efficiency with a combination of the workings of the second heat exchanger 28 described in the second embodiment and the workings of the third heat exchanger 38 described in the third embodiment.

In particular, the gas turbine systems 5A and 6A respectively shown in FIGS. 5 and 6 make it easier to pass the fuel through the second heat exchanger 28 at low temperature and make it easier to increase the difference in temperature between the working fluid and the fuel in the second heat exchanger 28 than the gas turbine systems 7A and 8A respectively shown in FIGS. 7 and 8. This is advantageous from the point of view of miniaturization of the second heat exchanger 28. Further, the gas turbine systems 5A and 6A have an advantage from the point of view of obtaining low-temperature heat at low temperature by lowering the temperature of the working fluid on a suction side of the expansion mechanism 22.

Meanwhile, the gas turbine systems 7A and 8A respectively shown in FIGS. 7 and 8 make it easier to pass the fuel through the third heat exchanger 38 at low temperature, make it easier to lower the temperature of the working fluid through the heat exchange performed by the third heat exchanger 38, and make it easier for the second compressor 21 to breathe the working fluid at low temperature than the gas turbine systems 5A and 6A respectively shown in FIGS. 5 and 6. This is advantageous from the point of view of enhancing compression efficiency of the second compressor 21, raising the pressure of the working fluid on the suction side of the expansion mechanism 22, increasing torque that is produced in the expansion mechanism 22, and increasing electric power that is generated in the motor generator 23.

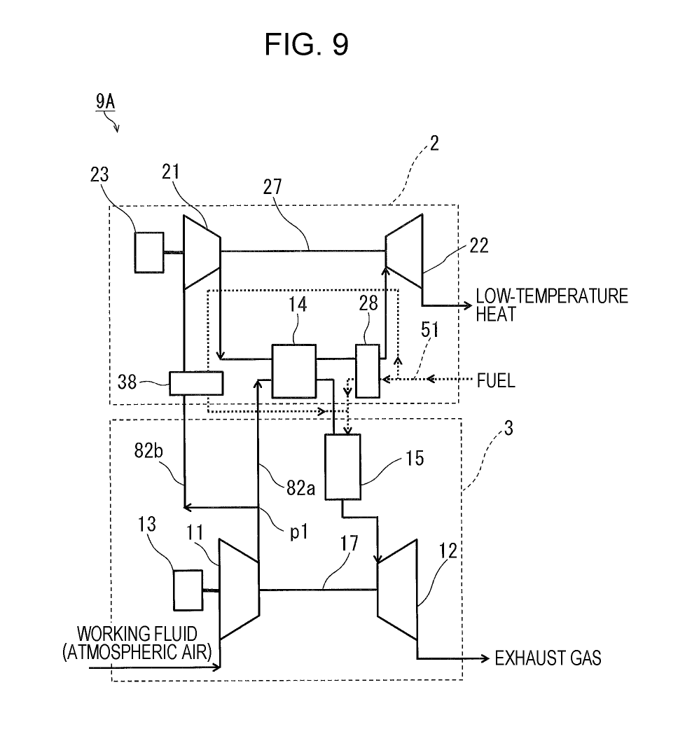

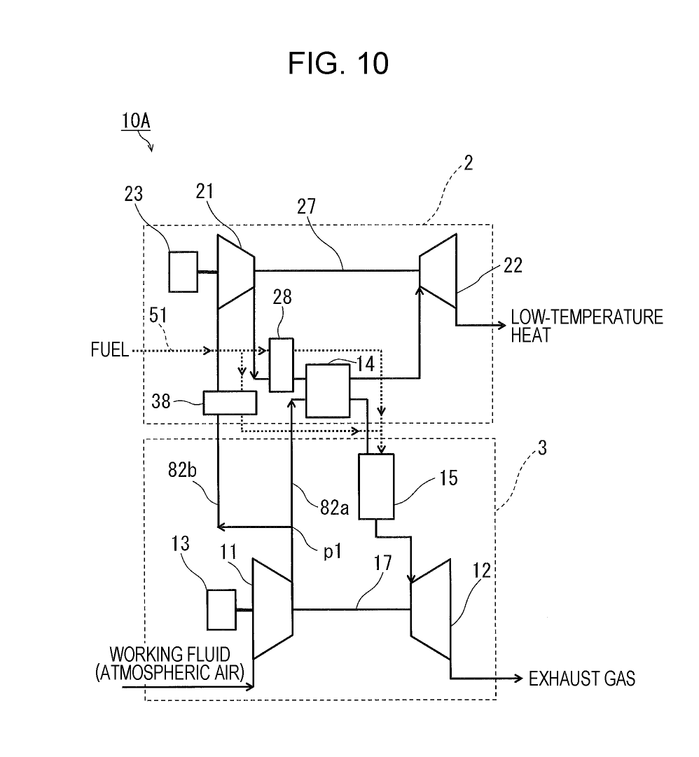

In each of the respective gas turbine systems 5A to 8A of FIGS. 5 to 8, the second heat exchanger 28 and the third heat exchanger 38 are connected in series on the fuel supply route 51. Note, however, that as shown in FIGS. 9 and 10, the second heat exchanger 28 and the third heat exchanger 38 may be connected in parallel on the fuel supply route 51.

Connecting the second heat exchanger 28 and the third heat exchanger 38 in series is advantageous from the point of view of raising the temperature of the fuel that is supplied to the combustor 15 and enhancing the efficiency of the gas turbine system. Meanwhile, connecting the second heat exchanger 28 and the third heat exchanger 38 in parallel makes it possible to cool the working fluid with the fuel at low temperature in both the second heat exchanger 28 and the third heat exchanger 38. This is advantageous from the point of view of obtaining the working fluid at low temperature. The parallel connection between the second heat exchanger 28 and the third heat exchanger 38 is easily made in a case where the amount of consumption of the fuel is large and the amount of the working fluid that needs to be supplied at low temperature is small.

In a gas turbine system 9A shown in FIG. 9, as in the example shown in FIG. 2, the second heat exchanger 28 performs a heat exchange between the working fluid having flowed out from the first heat exchanger 14 and to be expanded by the expansion mechanism 22 and the fuel.

The gas turbine system 9A shown in FIG. 9 may also be described as below with use of the terms “path” and “supply route”. In the gas turbine system 9A, the second path 82b connects the connecting point p1, the third heat exchanger 38, the second compressor 21, the first heat exchanger 14, the second heat exchanger 28, and the expansion mechanism 22 in this order. The fuel supply route 51 connects the fuel tank (not illustrated), the parallel connection between the second heat exchanger 28 and the third heat exchanger 38, and the combustor 15 in this order.

In a gas turbine system 10A shown in FIG. 10, as in the example shown in FIG. 3, the second heat exchanger 28 performs a heat exchange between the working fluid compressed by the second compressor 21 and to flow into the first heat exchanger 14 and the fuel.

The gas turbine system 10A shown in FIG. 10 may also be described as below with use of the terms “path” and “supply route”. In the gas turbine system 10A, the second path 82b connects the connecting point p1, the third heat exchanger 38, the second compressor 21, the second heat exchanger 28, the first heat exchanger 14, and the expansion mechanism 22 in this order. The fuel supply route 51 connects the fuel tank (not illustrated), the parallel connection between the second heat exchanger 28 and the third heat exchanger 38, and the combustor 15 in this order.

### Fifth Embodiment

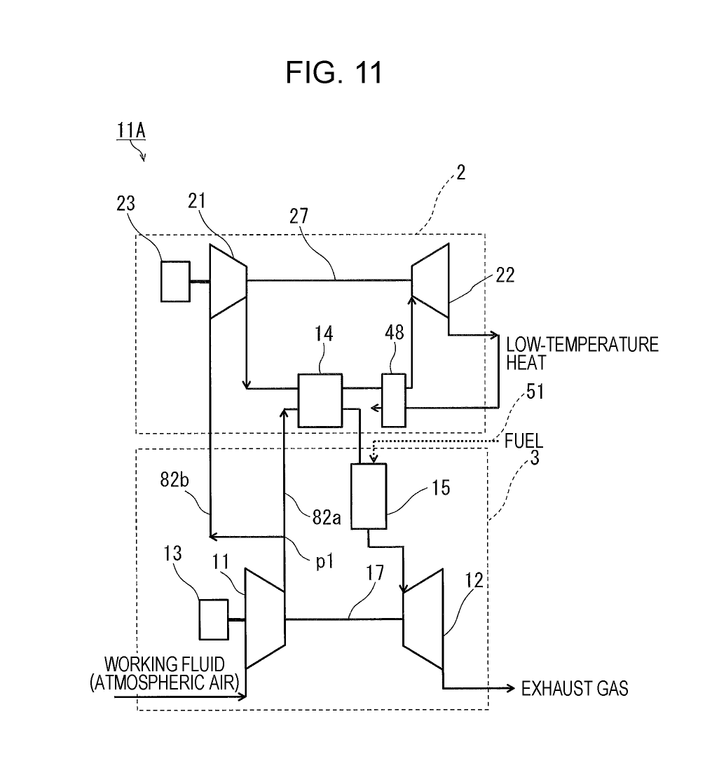

FIG. 11 is a block diagram of a gas turbine system 11A according to a fifth embodiment.

As shown in FIG. 11, the gas turbine system 11A includes a fourth heat exchanger 48. The fourth heat exchanger 48 is provided between the second compressor 21 and the expansion mechanism 22. Specifically, the fourth heat exchanger 48 is provided between the first heat exchanger 14 and the expansion mechanism 22.

The fourth heat exchanger 48 performs a heat exchange between the working fluid compressed by the second compressor 21 and to be expanded by the expansion mechanism 22 and the working fluid discharged from the expansion mechanism 22. Specifically, the fourth heat exchanger 48 performs a heat exchange between the working fluid having flowed out from the first heat exchanger 14 and to be expanded by the expansion mechanism 22 and the working fluid discharged from the expansion mechanism 22. An example of the fourth heat exchanger 48 is a fin tube heat exchanger, a plate tube heat exchanger, a plate heat exchanger, or the like.

As mentioned above, in the fifth embodiment, the fourth heat exchanger 48 performs a heat exchange between the working fluid having flowed out from the first heat exchanger 14 and the working fluid discharged from the expansion mechanism 22. This heat exchange lowers the temperature of the working fluid having flowed out from the first heat exchanger 14. This heat exchange contributes to improvement in efficiency of the gas turbine system 11A.

Further, in the presence of the fourth heat exchanger 48, the temperature of the working fluid that is discharged from the expansion mechanism 22 can be made lower than in the absence of the fourth heat exchanger 48.

The gas turbine system 11A shown in FIG. 11 may also be described as below with use of the term “path”. In the gas turbine system 11A, the second path 82b connects the connecting point p1, the second compressor 21, the first heat exchanger 14, the fourth heat exchanger 48, the expansion mechanism 22, and the fourth heat exchanger 48 in this order.

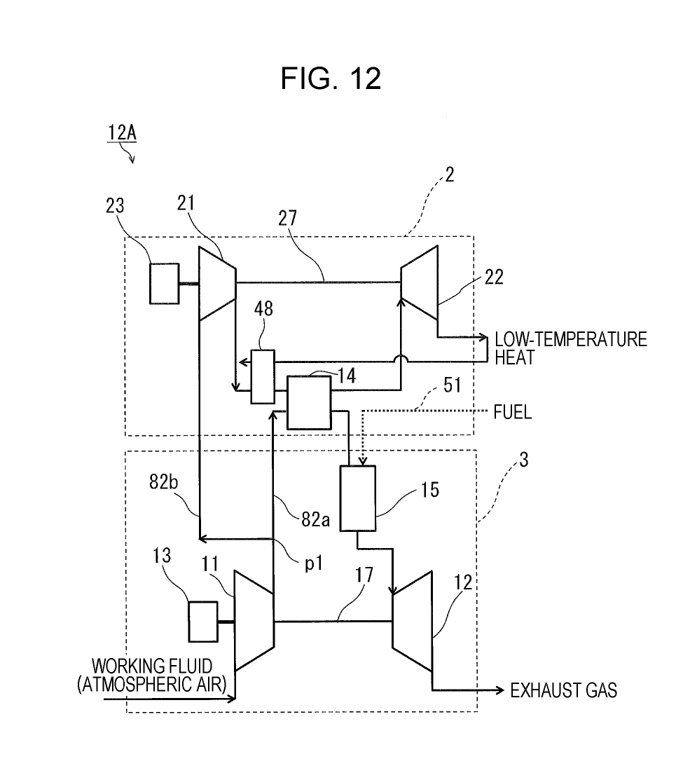

The placement of the fourth heat exchanger 48 is not limited to that shown in FIG. 11. In a gas turbine system 12A shown in FIG. 12, the fourth heat exchanger 48 is provided between the second compressor 21 and the first heat exchanger 14. The fourth heat exchanger 48 performs a heat exchange between the working fluid compressed by the second compressor 21 and to flow into the first heat exchanger 14 and the working fluid discharged from the expansion mechanism 22. In this way, too, the heat exchange performed by the fourth heat exchanger 48 contributes to improvement in efficiency of the gas turbine system 12A for the same reason as that noted above.

The gas turbine system 12A shown in FIG. 12 may also be described as below with use of the term “path”. In the gas turbine system 12A, the second path 82b connects the connecting point p1, the second compressor 21, the fourth heat exchanger 48, the first heat exchanger 14, the expansion mechanism 22, and the fourth heat exchanger 48 in this order.

### Sixth Embodiment

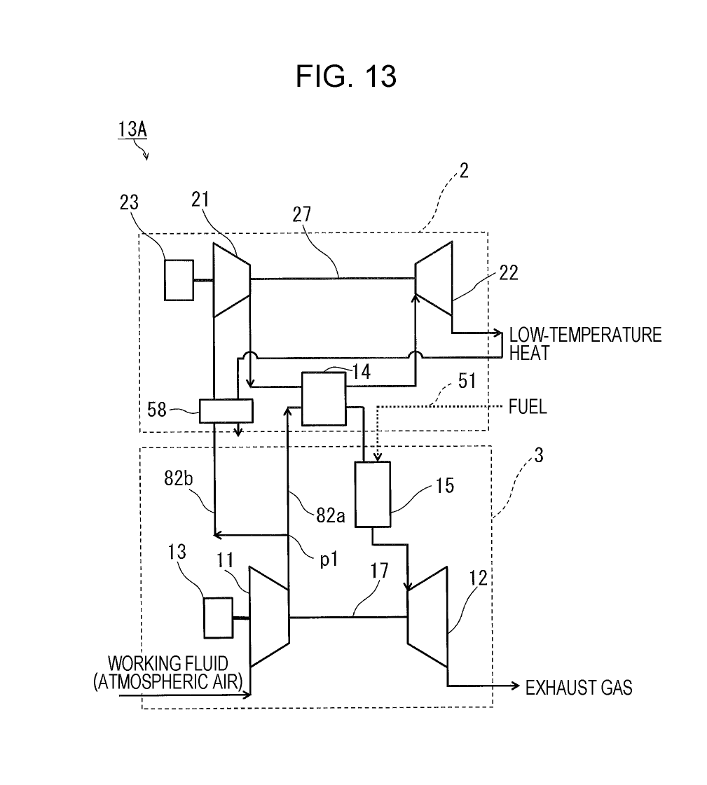

FIG. 13 is a block diagram of a gas turbine system 13A according to a sixth embodiment.

As shown in FIG. 13, the gas turbine system 13A includes a fifth heat exchanger 58.

As can be understood from the foregoing description, the second compressor 21 compresses the working fluid extracted from the connecting point p1 in the gas turbine apparatus 3 after having had its pressure raised by the first compressor 11. The fifth heat exchanger 58 performs a heat exchange between the working fluid extracted from the connecting point p1 and to be compressed by the second compressor 21 and the working fluid discharged from the expansion mechanism 22. An example of the fifth heat exchanger 58 is a fin tube heat exchanger, a plate tube heat exchanger, a plate heat exchanger, or the like.

The fifth heat exchanger 58 of the sixth embodiment contributes to improvement in efficiency of the gas turbine system 13A for the same reason as the third heat exchanger 38 of the third embodiment.

The gas turbine system 13A shown in FIG. 13 may also be described as below with use of the term “path”. In the gas turbine system 13A, the second path 82b connects the connecting point p1, the fifth heat exchanger 58, the second compressor 21, the first heat exchanger 14, the expansion mechanism 22, and the fifth heat exchanger 58 in this order.

### Seventh Embodiment

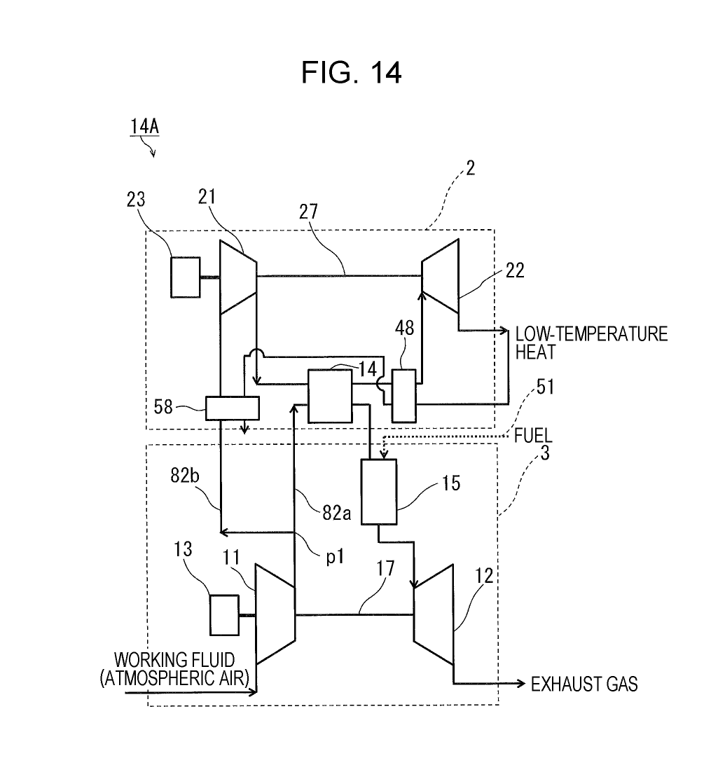

FIG. 14 is a block diagram of a gas turbine system 14A according to a seventh embodiment.

As shown in FIG. 14, the gas turbine system 14A includes the fourth heat exchanger 48 described with reference to FIG. 11 in the fifth embodiment and the fifth heat exchanger 58 described with reference to FIG. 13 in the sixth embodiment.

In the gas turbine system 14A of FIG. 14, the fourth heat exchanger 48 performs a heat exchange between the working fluid compressed by the second compressor 21 and to be expanded by the expansion mechanism 22 and the working fluid discharged from the expansion mechanism 22. The fifth heat exchanger 58 performs a heat exchange between the working fluid extracted from the connecting point p1 and to be compressed by the second compressor 21 and the working fluid discharged from the expansion mechanism 22. The working fluid discharged from the expansion mechanism 22 passes through the fourth heat exchanger 48 first and then passes through the fifth heat exchanger 58. As will be mentioned in a fourteenth embodiment, the working fluid discharged from the expansion mechanism 22 may pass through the fourth heat exchanger 48 first, then pass through the fifth heat exchanger 58, and then be guided into the first turbine 12.

Specifically, as in the example shown in FIG. 11, the fourth heat exchanger 48 performs a heat exchange between the working fluid having flowed out from the first heat exchanger 14 and to be expanded by the expansion mechanism 22 and the working fluid discharged from the expansion mechanism 22.

The gas turbine system 14A shown in FIG. 14 may also be described as below with use of the term “path”. In the gas turbine system 14A, the second path 82b connects the connecting point p1, the fifth heat exchanger 58, the second compressor 21, the first heat exchanger 14, the fourth heat exchanger 48, the expansion mechanism 22, the fourth heat exchanger 48, and the fifth heat exchanger 58 in this order.

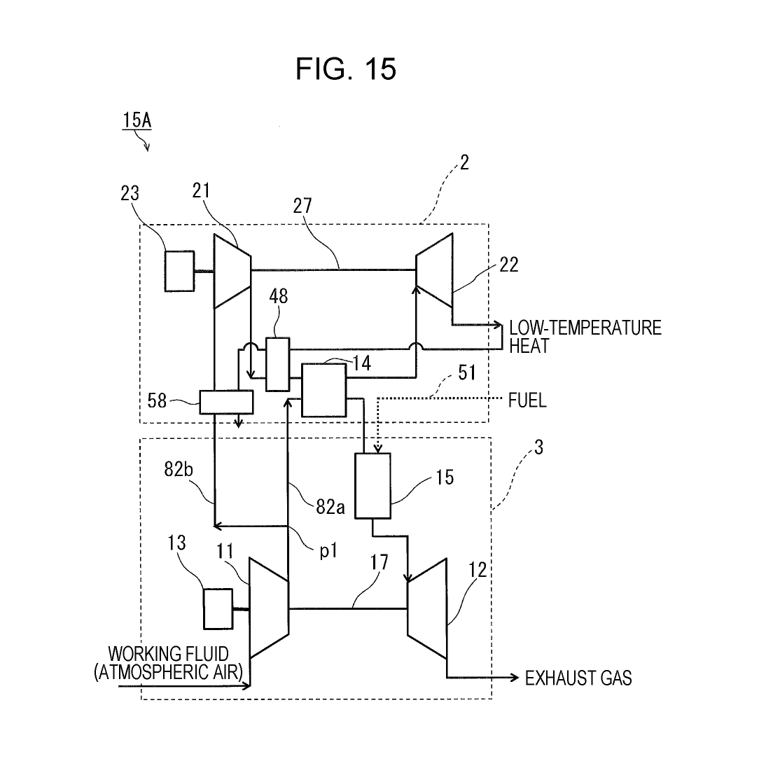

The placement of the fourth heat exchanger 48 is not limited to that shown in FIG. 14. In a gas turbine system 15A shown in FIG. 15, as in the example shown in FIG. 12, the fourth heat exchanger 48 performs a heat exchange between the working fluid compressed by the second compressor 21 and to flow into the first heat exchanger 14 and the working fluid discharged from the expansion mechanism 22.

The gas turbine system 15A shown in FIG. 15 may also be described as below with use of the term “path”. In the gas turbine system 15A, the second path 82b connects the connecting point p1, the fifth heat exchanger 58, the second compressor 21, the fourth heat exchanger 48, the first heat exchanger 14, the expansion mechanism 22, the fourth heat exchanger 48, and the fifth heat exchanger 58 in this order.

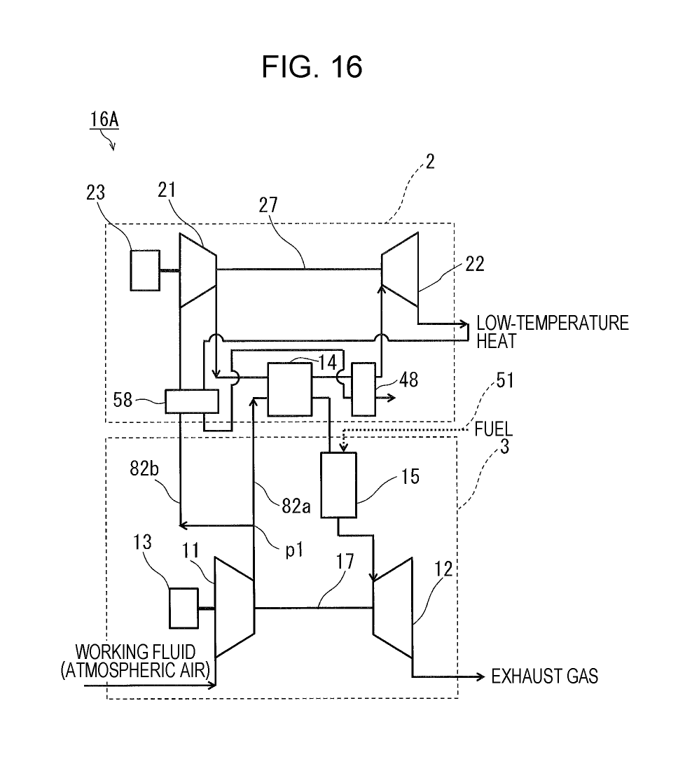

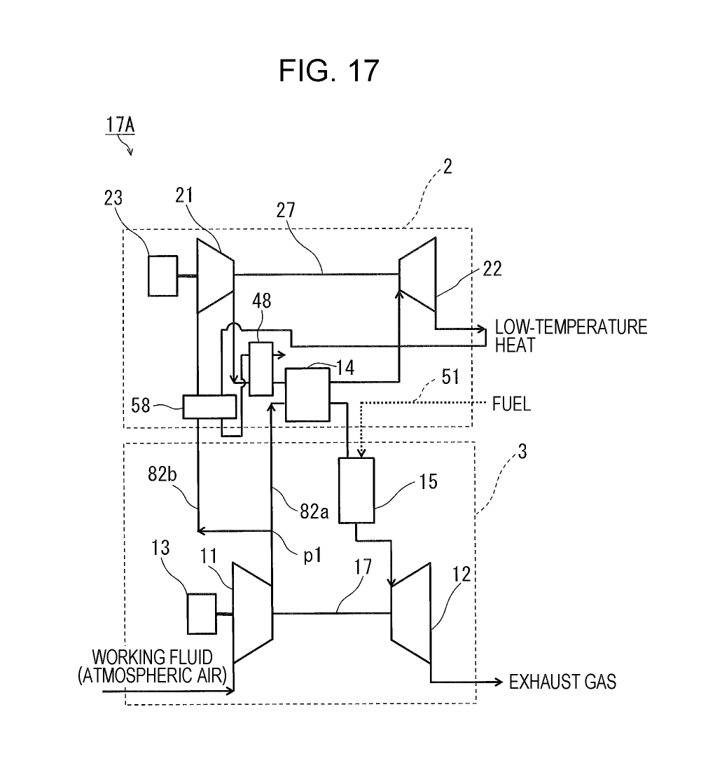

It is also possible to employ examples shown in FIGS. 16 and 17. In a gas turbine system 16A shown in FIG. 16 and a gas turbine system 17A shown in FIG. 17, the working fluid discharged from the expansion mechanism 22 passes through the fifth heat exchanger 58 first and then passes through the fourth heat exchanger 48. As will be mentioned in the fourteenth embodiment, the working fluid discharged from the expansion mechanism 22 may pass through the fifth heat exchanger 58 first, then pass through the fourth heat exchanger 48, and then be guided into the first turbine 12.

As in the example shown in FIG. 11, the fourth heat exchanger 48 of FIG. 16 performs a heat exchange between the working fluid having flowed out from the first heat exchanger 14 and to be expanded by the expansion mechanism 22 and the working fluid discharged from the expansion mechanism 22.

The gas turbine system 16A shown in FIG. 16 may also be described as below with use of the term “path”. In the gas turbine system 16A, the second path 82b connects the connecting point p1, the fifth heat exchanger 58, the second compressor 21, the first heat exchanger 14, the fourth heat exchanger 48, the expansion mechanism 22, the fifth heat exchanger 58, and the fourth heat exchanger 48 in this order.

As in the example shown in FIG. 12, the fourth heat exchanger 48 of FIG. 17 performs a heat exchange between the working fluid compressed by the second compressor 21 and to flow into the first heat exchanger 14 and the working fluid discharged from the expansion mechanism 22.

The gas turbine system 17A shown in FIG. 17 may also be described as below with use of the term “path”. In the gas turbine system 17A, the second path 82b connects the connecting point p1, the fifth heat exchanger 58, the second compressor 21, the fourth heat exchanger 48, the first heat exchanger 14, the expansion mechanism 22, the fifth heat exchanger 58, and the fourth heat exchanger 48 in this order.

The respective gas turbine systems 14A to 17A of FIGS. 14 to 17 attain high efficiency with a combination of the workings of the fourth heat exchanger 48 described in the fifth embodiment and the workings of the fifth heat exchanger 58 described in the sixth embodiment.

In particular, the gas turbine systems 14A and 15A respectively shown in FIGS. 14 and 15 make it easier to lower the temperature of the working fluid, discharged from the expansion mechanism 22, that flows through the fourth heat exchanger 48 and make it easier to increase the difference in temperature between the working fluids between which the fourth heat exchanger 48 performs a heat exchange than the gas turbine systems 16A and 17A respectively shown in FIGS. 16 and 17. This is advantageous from the point of view of miniaturization of the fourth heat exchanger 48. Further, the gas turbine systems 14A and 15A have an advantage from the point of view of obtaining low-temperature heat at low temperature by lowering the temperature of the working fluid on the suction side of the expansion mechanism 22.

Meanwhile, the gas turbine systems 16A and 17A respectively shown in FIGS. 16 and 17 make it easier to pass the fuel through the fifth heat exchanger 58 at low temperature, make it easier to lower the temperature of the working fluid through the heat exchange performed by the fifth heat exchanger 58, and make it easier for the second compressor 21 to breathe the working fluid at low temperature than the gas turbine systems 14A and 15A respectively shown in FIGS. 14 and 15. This is advantageous from the point of view of enhancing compression efficiency of the second compressor 21, raising the pressure of the working fluid on the suction side of the expansion mechanism 22, increasing torque that is produced in the expansion mechanism 22, and increasing electric power that is generated in the motor generator 23.

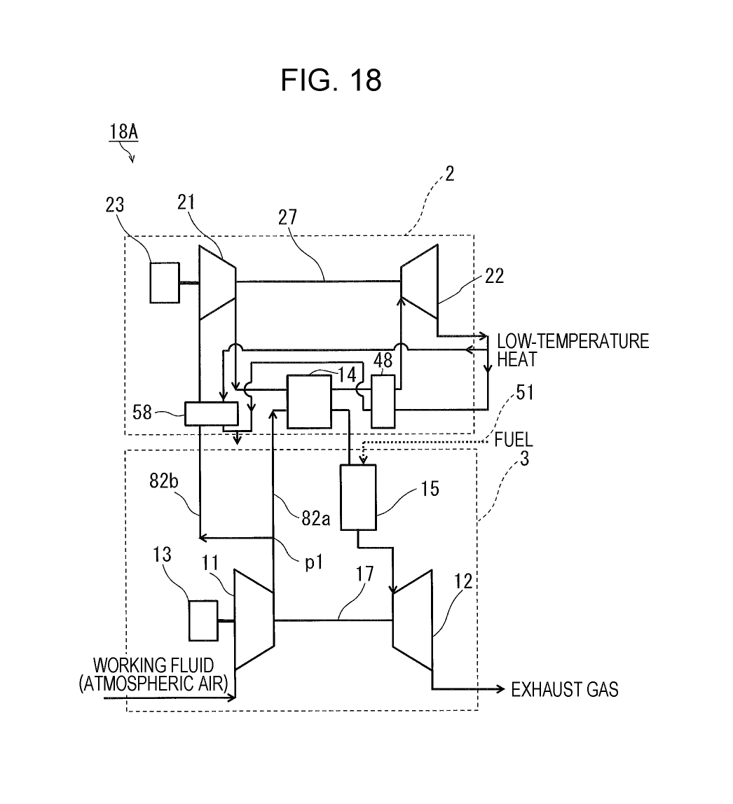

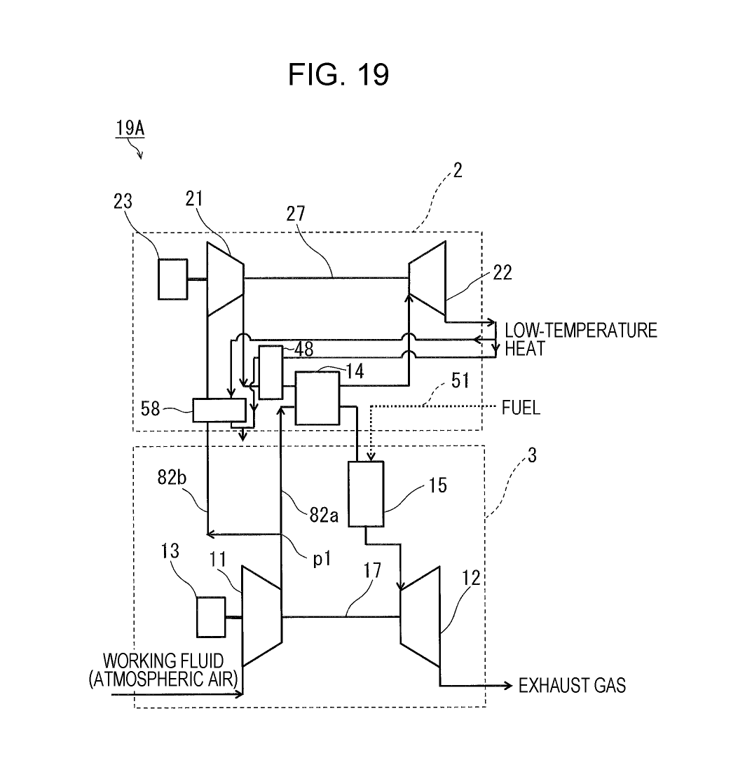

In each of the respective gas turbine systems 14A to 17A of FIGS. 14 to 17, the fourth heat exchanger 48 and the fifth heat exchanger 58 are connected in series on a downstream part of the second path 82b located downstream of the expansion mechanism 22. The term “downstream part” refers to a part through which the working fluid discharged from the expansion mechanism 22 flows. Note, however, that as shown in FIGS. 18 and 19, the fourth heat exchanger 48 and the fifth heat exchanger 58 may be connected in parallel on the downstream part. As will be mentioned in the fourteenth embodiment, the working fluid having flowed out from a parallel connection between the fourth heat exchanger 48 and the fifth heat exchanger 58 may be guided into the first turbine 12.

In a gas turbine system 18A shown in FIG. 18, as in the example shown in FIG. 11, the fourth heat exchanger 48 performs a heat exchange between the working fluid having flowed out from the first heat exchanger 14 and to be expanded by the expansion mechanism 22 and the working fluid discharged from the expansion mechanism 22.

The gas turbine system 18A shown in FIG. 18 may also be described as below with use of the term “path”. In the gas turbine system 18A, the second path 82b connects the connecting point p1, the fifth heat exchanger 58, the second compressor 21, the first heat exchanger 14, the fourth heat exchanger 48, the expansion mechanism 22, and the parallel connection between the fourth heat exchanger 48 and the fifth heat exchanger 58 in this order.

In a gas turbine system 19A shown in FIG. 19, as in the example shown in FIG. 12, the fourth heat exchanger 48 performs a heat exchange between the working fluid compressed by the second compressor 21 and to flow into the first heat exchanger 14 and the working fluid discharged from the expansion mechanism 22.

The gas turbine system 19A shown in FIG. 19 may also be described as below with use of the term “path”. In the gas turbine system 19A, the second path 82b connects the connecting point p1, the fifth heat exchanger 58, the second compressor 21, the fourth heat exchanger 48, the first heat exchanger 14, the expansion mechanism 22, and the parallel connection between the fourth heat exchanger 48 and the fifth heat exchanger 58 in this order.

### Eighth Embodiment

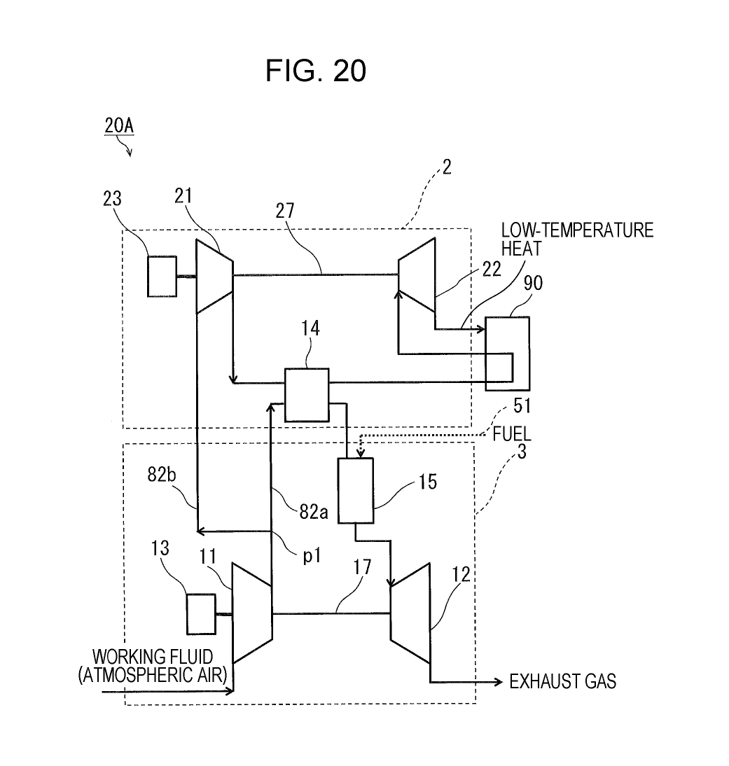

FIG. 20 is a block diagram of a gas turbine system 20A according to an eighth embodiment.

As shown in FIG. 20, the gas turbine system 20A includes a cooled room 90. The cooled room 90 is supplied with the working fluid discharged from the expansion mechanism 22. A path that guides the working fluid from the second compressor 21 into the expansion mechanism 22 passes through the cooled room 90. Specifically, a path that guides the working fluid from the first heat exchanger 14 into the expansion mechanism 22 passes through the cooled room 90.

The working fluid discharged from the expansion mechanism 22 flows into the cooled room 90. In this way, the cooled room 90 is cooled. The cooled room 90 may be cooled to below freezing. The cooled room 90 may be utilized, for example, in a food-processing plant as a warehouse in which foods such as fish are preserved by freezing.

The gas turbine system 20A shown in FIG. 20 may also be described as below with use of the term “path”. In the gas turbine system 20A, the second path 82b connects the connecting point p1, the second compressor 21, the first heat exchanger 14, the cooled room 90, the expansion mechanism 22, and the cooled room 90 in this order.

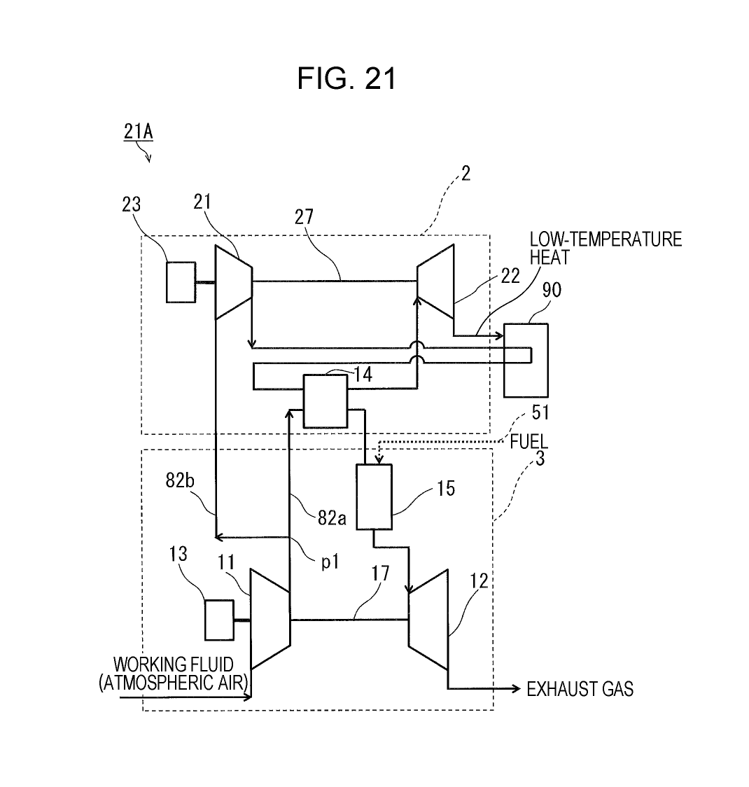

It is also possible to employ an example shown in FIG. 21. In a gas turbine system 21A shown in FIG. 21, a path that guides the working fluid from the second compressor 21 into the first heat exchanger 14 passes through the cooled room 90.

The gas turbine system 21A shown in FIG. 21 may also be described as below with use of the term “path”. In the gas turbine system 21A, the second path 82b connects the connecting point p1, the second compressor 21, the cooled room 90, the first heat exchanger 14, the expansion mechanism 22, and the cooled room 90 in this order.

The eighth embodiment has the advantage in improvement in efficiency of the gas turbine system 21A for the same reason as the fifth embodiment.

### Ninth Embodiment

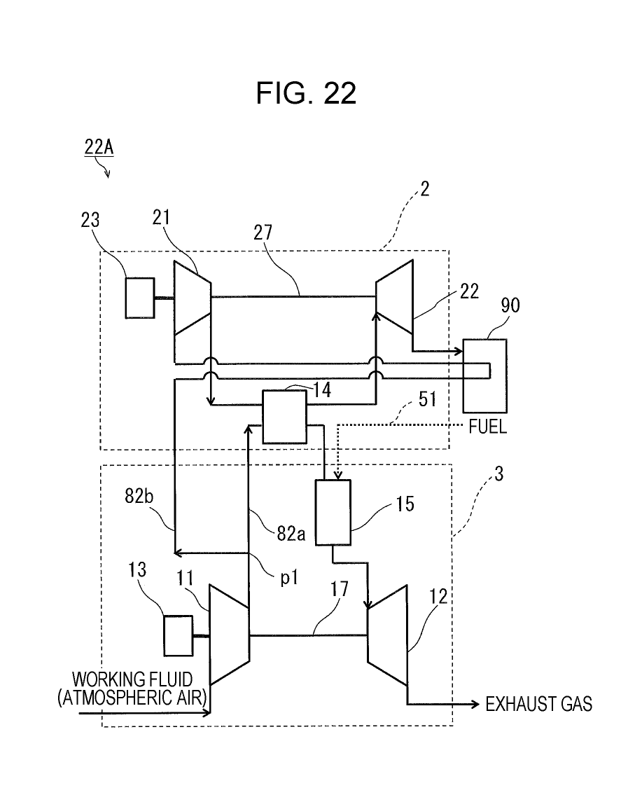

FIG. 22 is a block diagram of a gas turbine system 22A according to a ninth embodiment.

As can be understood from the foregoing description, the second compressor 21 compresses the working fluid extracted from the connecting point p1 in the gas turbine apparatus 3 after having had its pressure raised by the first compressor 11. Further, as shown in FIG. 22, the gas turbine system 22A includes the cooled room 90 described in the eighth embodiment. A path that guides the working fluid from the connecting point p1 into the second compressor 21 passes through the cooled room 90.

The gas turbine system 22A shown in FIG. 22 may also be described as below with use of the term “path”. In the gas turbine system 22A, the second path 82b connects the connecting point p1, the cooled room 90, the second compressor 21, the first heat exchanger 14, the expansion mechanism 22, and the cooled room 90 in this order.

The ninth embodiment has the advantage in improvement in efficiency of the gas turbine system 22A for the same reason as the sixth embodiment.

### Tenth Embodiment

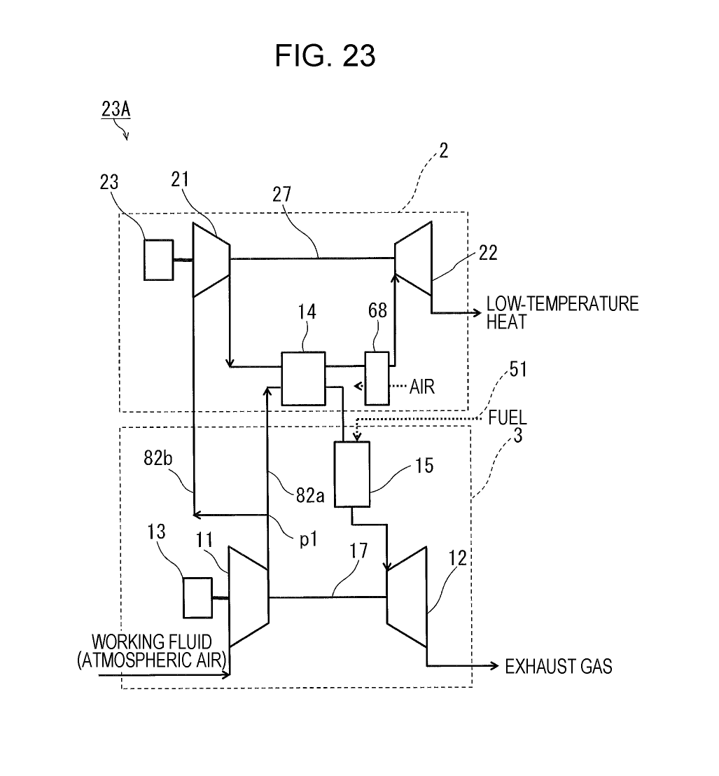

FIG. 23 is a block diagram of a gas turbine system 23A according to a tenth embodiment.

As shown in FIG. 23, the gas turbine system 23A includes a sixth heat exchanger 68. The sixth heat exchanger 68 is provided between the second compressor 21 and the expansion mechanism 22. Specifically, the sixth heat exchanger 68 is provided between the first heat exchanger 14 and the expansion mechanism 22.

The sixth heat exchanger 68 performs a heat exchange between the working fluid compressed by the second compressor 21 and to be expanded by the expansion mechanism 22 and air taken in from the atmosphere. Specifically, the sixth heat exchanger 68 performs a heat exchange between the working fluid having flowed out from the first heat exchanger 14 and to be expanded by the expansion mechanism 22 and the air taken in from the atmosphere. The sixth heat exchanger 68 is a heat exchanger that cools the working fluid by air cooling. An example of the sixth heat exchanger 68 is a fin tube heat exchanger, a plate tube heat exchanger, a plate heat exchanger, or the like.

As mentioned above, in the tenth embodiment, the sixth heat exchanger 68 performs a heat exchange between the working fluid having flowed out from the first heat exchanger 14 and the air taken in from the atmosphere. This heat exchange lowers the temperature of the working fluid having flowed out from the first heat exchanger 14. This heat exchange contributes to improvement in efficiency of the gas turbine system 23A.

A pump may be used to supply the air in the atmosphere to the sixth heat exchanger 68. However, the motive power needed for a pump to pressure-feed the air is smaller than the motive power needed for a pump to pressure-feed the cooling water to the intercooler 116 of Japanese Unexamined Patent Application Publication No. 2017-137858. Providing a pump, if any, to supply the air in the atmosphere to the sixth heat exchanger 68 will not greatly impair the efficiency of the gas turbine system 23A. Further, in a case where the gas turbine system 23A is mounted on a moving body such as a vehicle or an aircraft, a movement of the moving body causes the air in the atmosphere to be naturally supplied to the sixth heat exchanger 68. In these respects, the same applies to the after-mentioned seventh heat exchanger 78.

Further, in the presence of the sixth heat exchanger 68, the temperature of the working fluid that is discharged from the expansion mechanism 22 can be made lower than in the absence of the sixth heat exchanger 68.

The gas turbine system 23A shown in FIG. 23 may also be described as below with use of the term “path”. In the gas turbine system 23A, the second path 82b connects the connecting point p1, the second compressor 21, the first heat exchanger 14, the sixth heat exchanger 68, and the expansion mechanism 22 in this order.

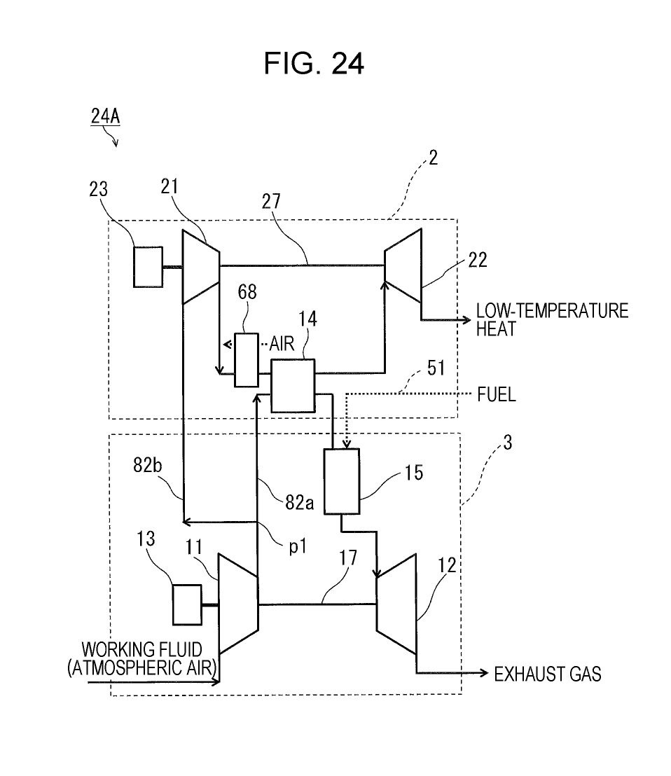

The placement of the sixth heat exchanger 68 is not limited to that shown in FIG. 23. In a gas turbine system 24A shown in FIG. 24, the sixth heat exchanger 68 is provided between the second compressor 21 and the first heat exchanger 14. The sixth heat exchanger 68 performs a heat exchange between the working fluid compressed by the second compressor 21 and to flow into the first heat exchanger 14 and the air taken in from the atmosphere. In this way, too, the heat exchange performed by the sixth heat exchanger 68 contributes to improvement in efficiency of the gas turbine system 24A for the same reason as that noted above.

The gas turbine system 24A shown in FIG. 24 may also be described as below with use of the term “path”. In the gas turbine system 24A, the second path 82b connects the connecting point p1, the second compressor 21, the sixth heat exchanger 68, the first heat exchanger 14, and the expansion mechanism 22 in this order.

### Eleventh Embodiment

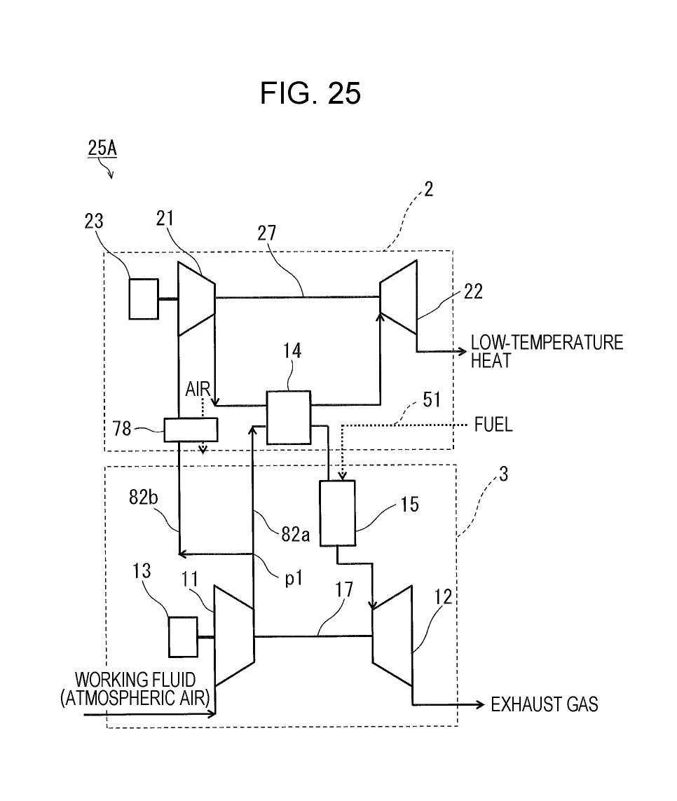

FIG. 25 is a block diagram of a gas turbine system 25A according to an eleventh embodiment.

As shown in FIG. 25, the gas turbine system 25A includes a seventh heat exchanger 78.

As can be understood from the foregoing description, the second compressor 21 compresses the working fluid extracted from the connecting point p1 in the gas turbine apparatus 3 after having had its pressure raised by the first compressor 11. The seventh heat exchanger 78 performs a heat exchange between the working fluid extracted from the connecting point p1 and to be compressed by the second compressor 21 and the air taken in from the atmosphere. The seventh heat exchanger 78 is a heat exchanger that cools the working fluid by air cooling. An example of the seventh heat exchanger 78 is a fin tube heat exchanger, a plate tube heat exchanger, a plate heat exchanger, or the like.

The seventh heat exchanger 78 of the eleventh embodiment contributes to improvement in efficiency of the gas turbine system 25A for the same reason as the third heat exchanger 38 of the third embodiment.

The gas turbine system 25A shown in FIG. 25 may also be described as below with use of the term “path”. In the gas turbine system 25A, the second path 82b connects the connecting point p1, the seventh heat exchanger 78, the second compressor 21, the first heat exchanger 14, and the expansion mechanism 22 in this order.

### Twelfth Embodiment

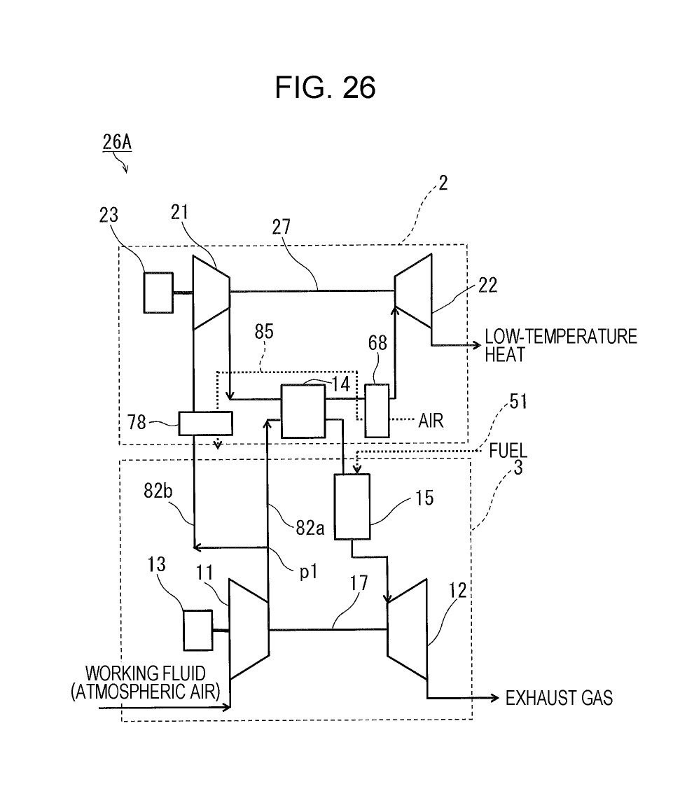

FIG. 26 is a block diagram of a gas turbine system 26A according to a twelfth embodiment.

As shown in FIG. 26, the gas turbine system 26A includes the sixth heat exchanger 68 described with reference to FIG. 23 in the tenth embodiment and the seventh heat exchanger 78 described with reference to FIG. 25 in the eleventh embodiment.

In the gas turbine system 26A of FIG. 26, the sixth heat exchanger 68 performs a heat exchange between the working fluid compressed by the second compressor 21 and to be expanded by the expansion mechanism 22 and the air taken in from the atmosphere. The seventh heat exchanger 78 performs a heat exchange between the working fluid extracted from the connecting point p1 and to be compressed by the second compressor 21 and the air taken in from the atmosphere. The gas turbine system 26A includes an air duct 85 that guides the air taken in from the atmosphere. The air duct 85 passes through the sixth heat exchanger 68 first and then passes through the seventh heat exchanger 78.

Specifically, as in the example shown in FIG. 23, the sixth heat exchanger 68 performs a heat exchange between the working fluid having flowed out from the first heat exchanger 14 and to be expanded by the expansion mechanism 22 and the air taken in from the atmosphere.

The gas turbine system 26A shown in FIG. 26 may also be described as below with use of the terms “path” and “air duct”. In the gas turbine system 26A, the second path 82b connects the connecting point p1, the seventh heat exchanger 78, the second compressor 21, the first heat exchanger 14, the sixth heat exchanger 68, and the expansion mechanism 22 in this order. The air duct 85 connects the sixth heat exchanger 68 and the seventh heat exchanger 78 in this order.

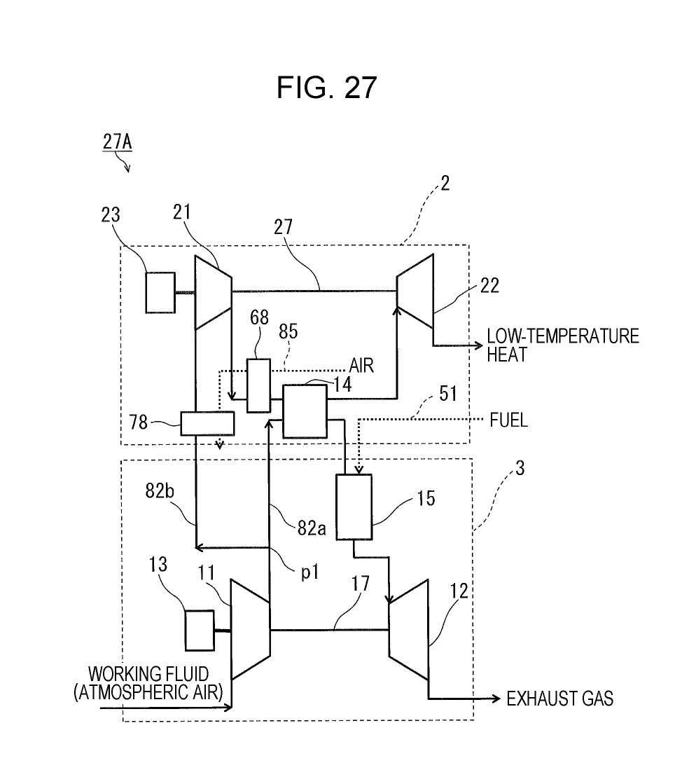

The placement of the sixth heat exchanger 68 is not limited to that shown in FIG. 26. In a gas turbine system 27A shown in FIG. 27, as in the example shown in FIG. 24, the sixth heat exchanger 68 performs a heat exchange between the working fluid compressed by the second compressor 21 and to flow into the first heat exchanger 14 and the air taken in from the atmosphere.

The gas turbine system 27A shown in FIG. 27 may also be described as below with use of the terms “path” and “air duct”. In the gas turbine system 27A, the sixth path 82b connects the connecting point p1, the seventh heat exchanger 78, the second compressor 21, the sixth heat exchanger 68, the first heat exchanger 14, and the expansion mechanism 22 in this order. The air duct 85 connects the sixth heat exchanger 68 and the seventh heat exchanger 78 in this order.

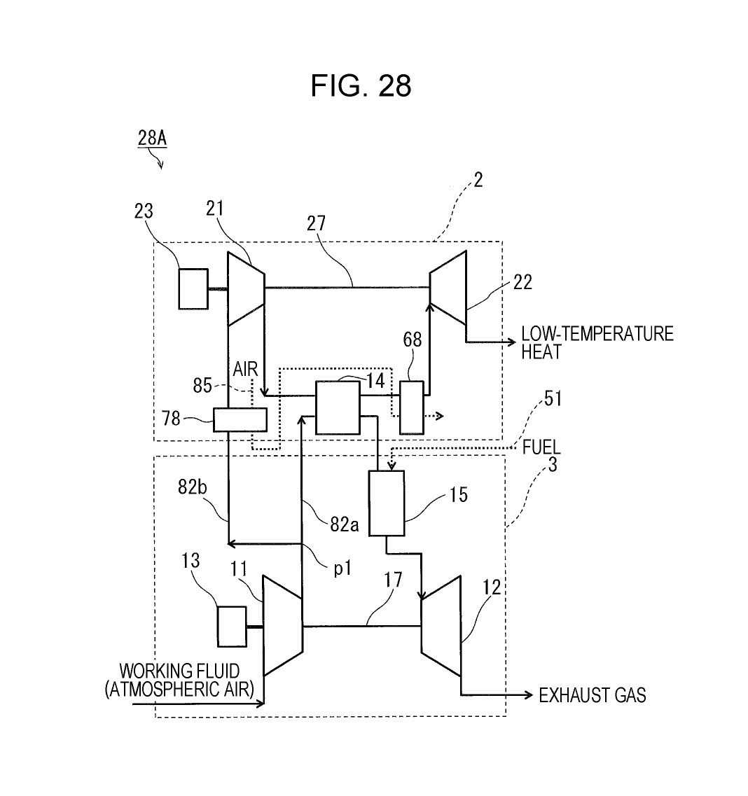

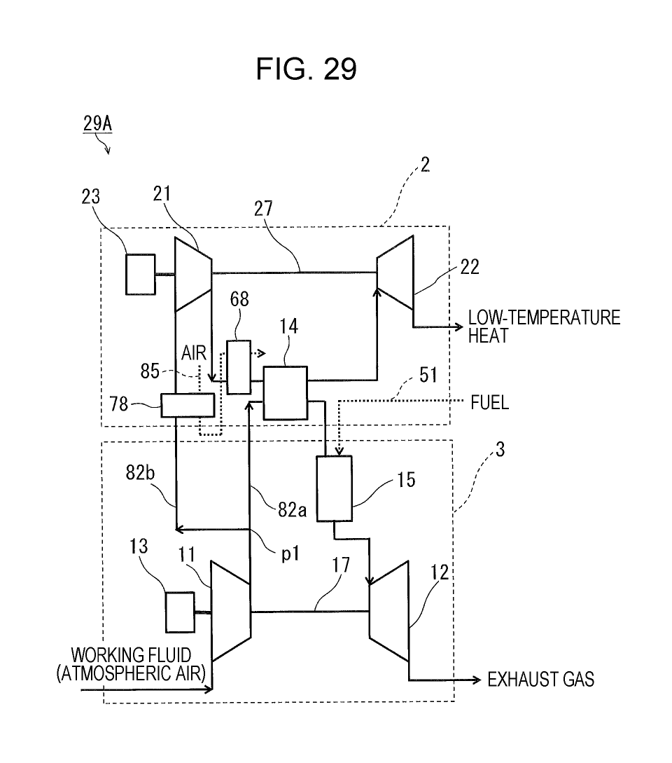

It is also possible to employ examples shown in FIGS. 28 and 29. In a gas turbine system 28A shown in FIG. 28 and a gas turbine system 29A shown in FIG. 29, the air duct 85 passes through the seventh heat exchanger 78 first and then passes through the sixth heat exchanger 68.

As in the example shown in FIG. 23, the sixth heat exchanger 68 of FIG. 28 performs a heat exchange between the working fluid having flowed out from the first heat exchanger 14 and to be expanded by the expansion mechanism 22 and the air taken in from the atmosphere.

The gas turbine system 28A shown in FIG. 28 may also be described as below with use of the terms “path” and “air duct”. In the gas turbine system 28A, the second path 82b connects the connecting point p1, the seventh heat exchanger 78, the second compressor 21, the first heat exchanger 14, the sixth heat exchanger 68, and the expansion mechanism 22 in this order. The air duct 85 connects the seventh heat exchanger 78 and the sixth heat exchanger 68 in this order.

As in the example shown in FIG. 24, the sixth heat exchanger 68 of FIG. 29 performs a heat exchange between the working fluid compressed by the second compressor 21 and to flow into the first heat exchanger 14 and the air taken in from the atmosphere.

The gas turbine system 29A shown in FIG. 29 may also be described as below with use of the terms “path” and “air duct”. In the gas turbine system 29A, the second path 82b connects the connecting point p1, the seventh heat exchanger 78, the second compressor 21, the sixth heat exchanger 68, the first heat exchanger 14, and the expansion mechanism 22 in this order. The air duct 85 connects the seventh heat exchanger 78 and the sixth heat exchanger 68 in this order.

The respective gas turbine systems 26A to 29A of FIGS. 26 to 29 attain high efficiency with a combination of the workings of the sixth heat exchanger 68 described in the tenth embodiment and the workings of the seventh heat exchanger 78 described in the eleventh embodiment.

In particular, the gas turbine systems 26A and 27A respectively shown in FIGS. 26 and 27 make it easier to lower the temperature of the air flowing through the sixth heat exchanger 68 and make it easier to increase the difference in temperature between the working fluid and the air in the sixth heat exchanger 68 than the gas turbine systems 28A and 29A respectively shown in FIGS. 28 and 29. This is advantageous from the point of view of miniaturization of the sixth heat exchanger 68. Further, the gas turbine systems 26A and 27A have an advantage from the point of view of obtaining low-temperature heat at low temperature by lowering the temperature of the working fluid on the suction side of the expansion mechanism 22.

Meanwhile, the gas turbine systems 28A and 29A respectively shown in FIGS. 28 and 29 make it easier to pass the fuel through the seventh heat exchanger 78 at low temperature, make it easier to lower the temperature of the working fluid through the heat exchange performed by the seventh heat exchanger 78, and make it easier for the second compressor 21 to breathe the working fluid at low temperature than the gas turbine systems 26A and 27A respectively shown in FIGS. 26 and 27. This is advantageous from the point of view of enhancing compression efficiency of the second compressor 21, raising the pressure of the working fluid on the suction side of the expansion mechanism 22, increasing torque that is produced in the expansion mechanism 22, and increasing electric power that is generated in the motor generator 23.

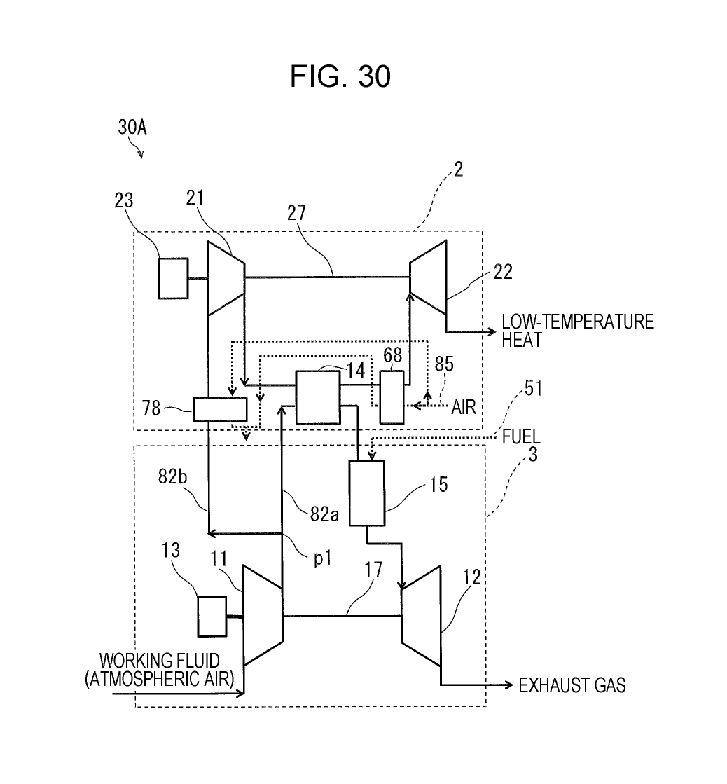

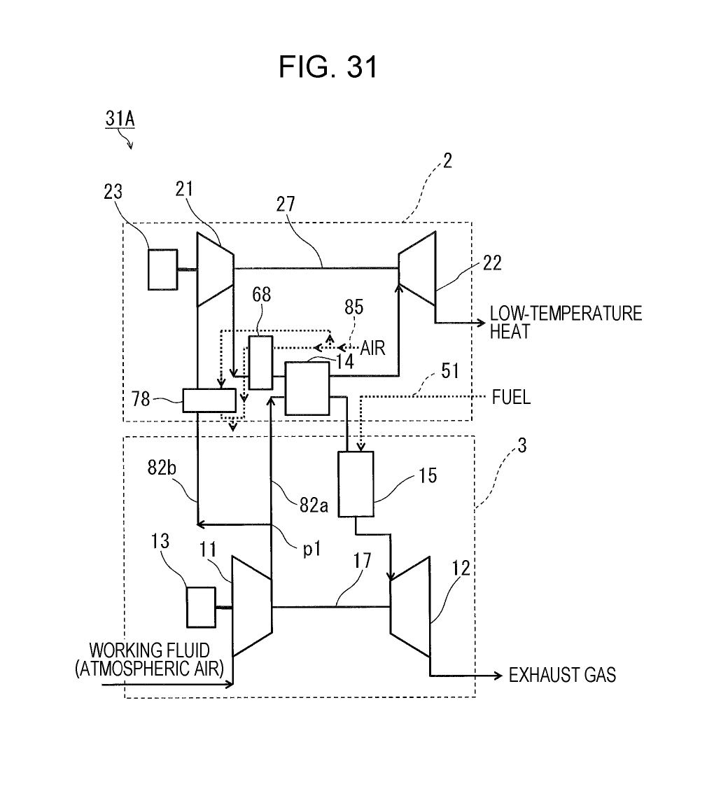

In each of the respective gas turbine systems 26A to 29A of FIGS. 26 to 29, the sixth heat exchanger 68 and the seventh heat exchanger 78 are connected in series on the air duct 85. Note, however, that as shown in FIGS. 30 and 31, the sixth heat exchanger 68 and the seventh heat exchanger 78 may be connected in parallel on the air duct 85.

In a gas turbine system 30A shown in FIG. 30, as in the example shown in FIG. 23, the sixth heat exchanger 68 performs a heat exchange between the working fluid having flowed out from the first heat exchanger 14 and to be expanded by the expansion mechanism 22 and the air taken in from the atmosphere.

The gas turbine system 30A shown in FIG. 30 may also be described as below with use of the terms “path” and “air duct”. In the gas turbine system 30A, the second path 82b connects the connecting point p1, the seventh heat exchanger 78, the second compressor 21, the first heat exchanger 14, the sixth heat exchanger 68, and the expansion mechanism 22 in this order. The air duct 85 connects the sixth heat exchanger 68 and the seventh heat exchanger 78 in parallel.

In a gas turbine system 31A shown in FIG. 31, as in the example shown in FIG. 24, the sixth heat exchanger 68 performs a heat exchange between the working fluid compressed by the second compressor 21 and to flow into the first heat exchanger 14 and the air taken in from the atmosphere.

The gas turbine system 31A shown in FIG. 31 may also be described as below with use of the terms “path” and “air duct”. In the gas turbine system 31A, the second path 82b connects the connecting point p1, the seventh heat exchanger 78, the second compressor 21, the sixth heat exchanger 68, the first heat exchanger 14, and the expansion mechanism 22 in this order. The air duct 85 connects the sixth heat exchanger 68 and the seventh heat exchanger 78 in parallel.

### Thirteenth Embodiment

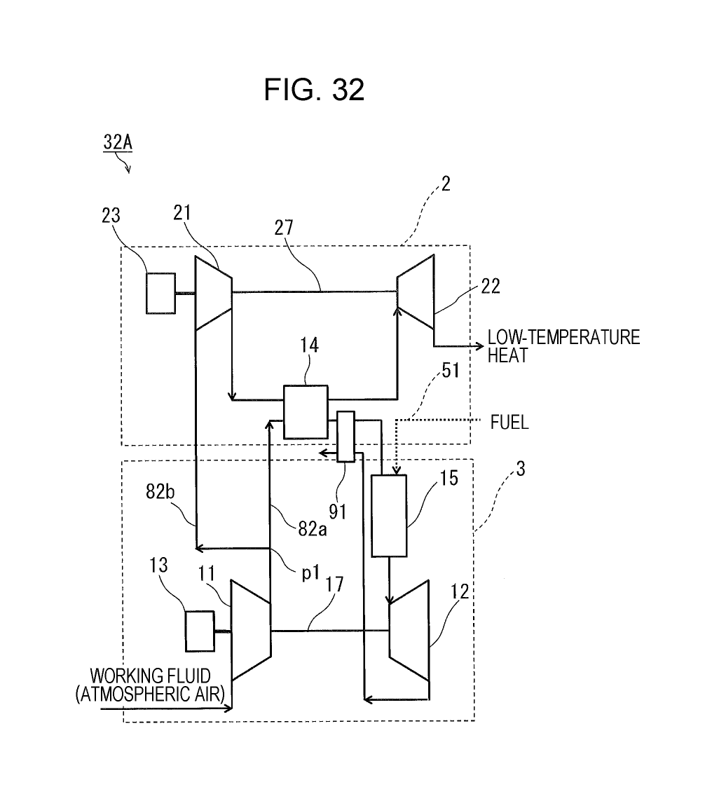

FIG. 32 is a block diagram of a gas turbine system 32A according to a thirteenth embodiment.

As shown in FIG. 32, the gas turbine system 32A includes a regenerative heat exchanger 91. The regenerative heat exchanger 91 is provided between the first heat exchanger 14 and the combustor 15.

The regenerative heat exchanger 91 performs a heat exchange between a working fluid that is combustion gas discharged from the first turbine 12 and the working fluid having flowed out from the first heat exchanger 14 and to flow into the combustor 15. An example of the regenerative heat exchanger 91 is a plate-fin heat exchanger.

The regenerative heat exchanger 91 makes it possible to utilize exhaust heat from the first turbine 12 to heat the working fluid having flowed out from the first heat exchanger 14 and to flow into the combustor 15. This makes it possible to raise the temperature of the combustion gas that is supplied from the combustor 15 to the first turbine 12. This contributes to improvement in thermal efficiency of the first turbine 12, and by extension to improvement in efficiency of the gas turbine system 32A.

The gas turbine system 32A shown in FIG. 32 may also be described as below with use of the term “path”. In the gas turbine system 32A, the first path 82a connects the first compressor 11, the connecting point p1, the first heat exchanger 14, the regenerative heat exchanger 91, the combustor 15, the first turbine 12, and the regenerative heat exchanger 91 in this order.

The regenerative heat exchanger 91 is also applicable to the respective gas turbine systems 2A to 31A of FIGS. 2 to 31.

### Fourteenth Embodiment

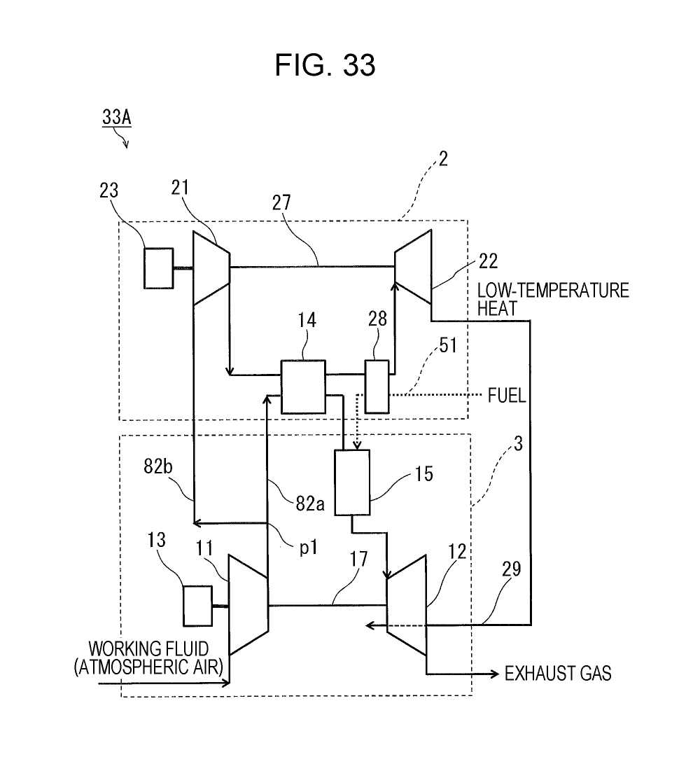

FIG. 33 is a block diagram of a gas turbine system 33A according to a fourteenth embodiment.

The gas turbine system 33A includes an introduction pipe 29. The introduction pipe 29 is a pipe through which the working fluid discharged from the expansion mechanism 22 is introduced into the first turbine 12.

In one example, the working fluid is sprayed onto an outer wall of a shell of the first turbine 12. In another example, the working fluid is introduced into the shell of the first turbine 12, cools the inside of the shell, and then is released out of the shell. Note here that the shell is a container in which the expansion mechanism 22 is accommodated.

The introduction pipe 29 makes it possible to introduce, into the first turbine 12, the working fluid discharged from the expansion mechanism 22. This working fluid makes it possible to cool the first turbine 12. This makes it possible to, while preventing the first turbine 12 from being burnt, raise the temperature of the working fluid flowing into the first turbine 12. This brings about improvement in thermal efficiency of the first turbine 12, allowing for improvement in efficiency of the gas turbine system 33A.

In a case where the ratio of the flow rate of the working fluid that is extracted from the connecting point p1 to the bleeding cycle apparatus 2 to the circulating amount of the working fluid that flows into the combustor 15 from the connecting point p1 is high, it is easy to secure the flow rate of the working fluid that flows through the introduction pipe 29.

The output W from the first turbine 12 depends on the pressure P of the working fluid on a suction side of the first turbine 12, the mass flow rate V of the working fluid on the suction side of the first turbine 12, and the quantity of heat Q of the working fluid on the suction side of the first turbine 12. Suppose here a case where the ratio of the circulating amount of the working fluid that flows into the combustor 15 from the connecting point p1 to the flow rate of the working fluid that is extracted from the connecting point p1 to the bleeding cycle apparatus 2 is low. In this case, it is not necessarily easy to secure a high flow rate V. In order to avoid deficiency in the output W from the first turbine 12 due to a low flow rate V, it is conceivable that the quantity of heat Q may be increased by supplying more fuel to the combustor 15. However, simply increasing the quantity of heat Q may cause the first turbine 12 to be burnt. In this respect, the fifteenth embodiment makes it hard for the first turbine 12 to be burnt even in a case where the quantity of heat Q of the working fluid is large, as the first turbine 12 can be cooled with a cold working fluid that is discharged from the expansion mechanism 22. This makes it possible to, while preventing the first turbine 12 from being burnt, secure the output W from the first turbine 12 by combusting more fuel to increase the quantity of heat Q. For example, even in a case where the mass flow rate V is low, the amount of electricity that is generated in the first turbine 12 can be secured.

The gas turbine system 33A shown in FIG. 33 may also be described as below with use of the term “path”. In the gas turbine system 33A, the second path 82b connects the connecting point p1, the second compressor 21, the first heat exchanger 14, the expansion mechanism 22, and the first turbine 12 in this order. Specifically, the second path 82b connects the connecting point p1, the second compressor 21, the first heat exchanger 14, the second heat exchanger 28, the expansion mechanism 22, and the first turbine 12 in this order.

The introduction pipe 29 is also applicable to the respective gas turbine systems 1A and 3A to 26A of FIGS. 1 and 3 to 32.

As mentioned above, in each of the respective gas turbine systems 14A to 17A of FIGS. 14 to 17, the working fluid discharged from the expansion mechanism 22 passes through the fourth heat exchanger 48 and the fifth heat exchanger 58. The working fluid discharged from the expansion mechanism 22 may be guided into the first turbine 12 after having passed through the fourth heat exchanger 48 and the fifth heat exchanger 58.

As mentioned above, in each of the respective gas turbine systems 18A and 19A of FIGS. 18 and 19, the working fluid discharged from the expansion mechanism 22 passes through the parallel connection between the fourth heat exchanger 48 and the fifth heat exchanger 58. The working fluid having flowed out from this parallel connection may be guided into the first turbine 12.

### Fifteenth Embodiment

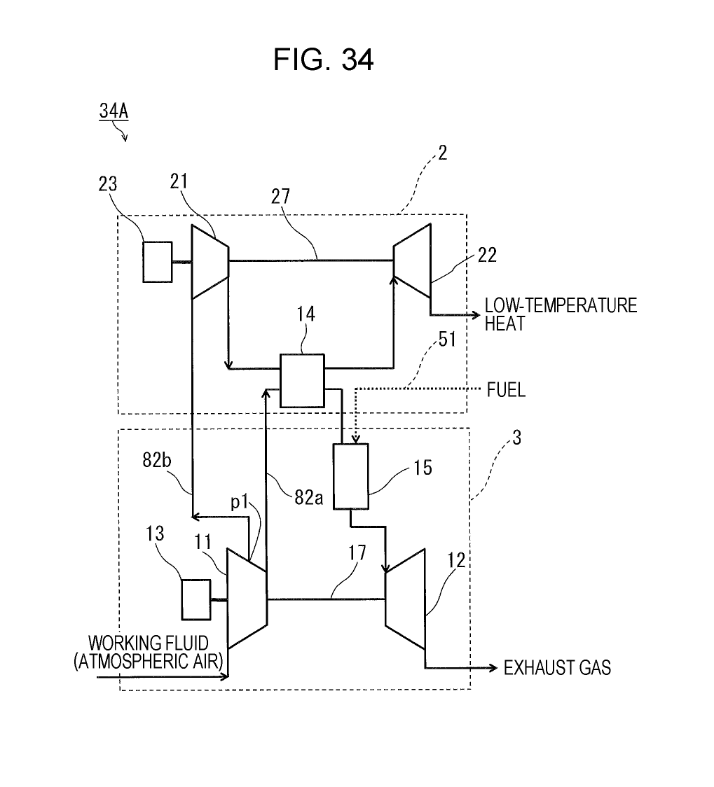

FIG. 34 is a block diagram of a gas turbine system 34A according to a fifteenth embodiment.

The first embodiment described earlier with reference to FIG. 1 employs a first form in which the working fluid compressed by the first compressor 11 is extracted and the working fluid is used as bled fluid in the bleeding cycle apparatus 2. On the other hand, the fifteenth embodiment shown in FIG. 34 employs a second form in which the working fluid being compressed by the first compressor 11 is extracted from an intermediate pressure position in the first compressor 11 and the working fluid is used as bled fluid in the bleeding cycle apparatus 2.

The expression “second compressor 21 that compresses the working fluid, extracted from the gas turbine apparatus 3, whose pressure has been raised by the first compressor 11” is an expression that is used with the intention to encompass both a case where the bled fluid extracted in the first form is compressed by the second compressor 21 and a case where the bled fluid extracted in the second form is compressed by the second compressor 21.

The gas turbine system 34A shown in FIG. 34 is further described. In the gas turbine system 34A, the connecting point p1 is set at an outlet of the first compressor 11 in the intermediate pressure position. In the gas turbine system 34A, the second path 82b connects the connecting point p1, the second compressor 21, the first heat exchanger 14, and the expansion mechanism 22 in this order. The first path 82a connects the first compressor 11, the first heat exchanger 14, the combustor 15, and the first turbine 12 in this order.

A gas turbine system according to the present disclosure is suitably applicable to facilities that use low-temperature heat, power generation, and high-temperature heat in the fields of food supermarkets, food-processing plants, vehicles, medicine, biotechnology, and the like.

What is claimed is:

1. A gas turbine system comprising:
a gas turbine apparatus including a first compressor that compresses a working fluid, a combustor that injects a fuel into the working fluid discharged from the first compressor and combusts the fuel, and a first turbine that expands combustion gas produced in the combustor;
a bleeding cycle apparatus including a second compressor that compresses the working fluid, extracted from the gas turbine apparatus, whose pressure has been raised by the first compressor and an expansion mechanism that expands the working fluid discharged from the second compressor; and
a first heat exchanger that performs a heat exchange between (i) the working fluid compressed by the first compressor and to be expanded by the first turbine and (ii) the working fluid compressed by the second compressor and to be expanded by the expansion mechanism.

2. The gas turbine system according to claim 1, further comprising a second heat exchanger that performs a heat exchange between (i) the working fluid compressed by the second compressor and to flow into the first heat exchanger and (ii) the fuel.

3. The gas turbine system according to claim 1, further comprising a second heat exchanger that performs a heat exchange between (i) the working fluid having flowed out from the first heat exchanger and to be expanded by the expansion mechanism and (ii) the fuel.

4. The gas turbine system according to claim 1, wherein the second compressor compresses the working fluid extracted from a connecting point in the gas turbine apparatus after having had its pressure raised by the first compressor,
the gas turbine system further comprising a third heat exchanger that performs a heat exchange between (i) the working fluid extracted from the connecting point and to be compressed by the second compressor and (ii) the fuel.

5. The gas turbine system according to claim 1, further comprising a second heat exchanger that performs a heat exchange between (i) the working fluid compressed by the second compressor and to be expanded by the expansion mechanism and (ii) the fuel,
wherein the second compressor compresses the working fluid extracted from a connecting point in the gas turbine apparatus after having had its pressure raised by the first compressor,
the gas turbine system further comprising a third heat exchanger that performs a heat exchange between (i) the working fluid extracted from the connecting point and to be compressed by the second compressor and (ii) the fuel,
wherein the fuel passes through the second heat exchanger first and then passes through the third heat exchanger.

6. The gas turbine system according to claim 1, further comprising a second heat exchanger that performs a heat exchange between the working fluid compressed by the second compressor and to be expanded by the expansion mechanism and the fuel,
wherein the second compressor compresses the working fluid extracted from a connecting point in the gas turbine apparatus after having had its pressure raised by the first compressor,
the gas turbine system further comprising a third heat exchanger that performs a heat exchange between (i) the working fluid extracted from the connecting point and to be compressed by the second compressor and (ii) the fuel,
wherein the fuel passes through the third heat exchanger first and then passes through the second heat exchanger.

7. The gas turbine system according to claim 1, further comprising a fourth heat exchanger that performs a heat exchange between (i) the working fluid having flowed out from the first heat exchanger and to be expanded by the expansion mechanism and (ii) the working fluid discharged from the expansion mechanism.

8. The gas turbine system according to claim 1, wherein the second compressor compresses the working fluid extracted from a connecting point in the gas turbine apparatus after having had its pressure raised by the first compressor,
the gas turbine system further comprising a fifth heat exchanger that performs a heat exchange between (i) the working fluid extracted from the connecting point and to be compressed by the second compressor and (ii) the working fluid discharged from the expansion mechanism.

9. The gas turbine system according to claim 1, further comprising a fourth heat exchanger that performs a heat exchange between (i) the working fluid having flowed out from the first heat exchanger and to be expanded by the expansion mechanism and (ii) the working fluid discharged from the expansion mechanism,
wherein the second compressor compresses the working fluid extracted from a connecting point in the gas turbine apparatus after having had its pressure raised by the first compressor,
the gas turbine system further comprising a fifth heat exchanger that performs a heat exchange between (i) the working fluid extracted from the connecting point and to be compressed by the second compressor and (ii) the working fluid discharged from the expansion mechanism,
wherein the working fluid discharged from the expansion mechanism passes through the fourth heat exchanger first and then passes through the fifth heat exchanger.

10. The gas turbine system according to claim 1, further comprising a fourth heat exchanger that performs a heat exchange between (i) the working fluid having flowed out from the first heat exchanger and to be expanded by the expansion mechanism and (ii) the working fluid discharged from the expansion mechanism,
wherein the second compressor compresses the working fluid extracted from a connecting point in the gas turbine apparatus after having had its pressure raised by the first compressor,
the gas turbine system further comprising a fifth heat exchanger that performs a heat exchange between (i) the working fluid extracted from the connecting point and to be compressed by the second compressor and (ii) the working fluid discharged from the expansion mechanism,
wherein the working fluid discharged from the expansion mechanism passes through the fifth heat exchanger first and then passes through the fourth heat exchanger.

11. The gas turbine system according to claim 1, further comprising a cooled room that is supplied with the working fluid discharged from the expansion mechanism,
wherein a path that guides the working fluid from the first heat exchanger into the expansion mechanism passes through the cooled room.

12. The gas turbine system according to claim 1, wherein the second compressor compresses the working fluid extracted from a connecting point in the gas turbine apparatus after having had its pressure raised by the first compressor,
the gas turbine system further comprising a cooled room that is supplied with the working fluid discharged from the expansion mechanism,
wherein a path that guides the working fluid from the connecting point into the second compressor passes through the cooled room.

13. The gas turbine system according to claim 1, further comprising a regenerative heat exchanger that performs a heat exchange between (i) the combustion gas discharged from the first turbine and (ii) the working fluid having flowed out from the first heat exchanger and to flow into the combustor.

14. The gas turbine system according to claim 1, further comprising an introduction pipe through which the working fluid discharged from the expansion mechanism is introduced into the first turbine.

15. A gas turbine system comprising:
a gas turbine apparatus including a first compressor that compresses a working fluid, a combustor that injects a fuel into the working fluid discharged from the first compressor and combusts the fuel, and a first turbine that expands combustion gas produced in the combustor;
a bleeding cycle apparatus including
a second compressor that compresses the working fluid, extracted from a connecting point in the gas turbine apparatus, whose pressure has been raised by the first compressor, and
an expansion mechanism that expands the working fluid discharged from the second compressor;
a second heat exchanger that performs a heat exchange between (i) the working fluid having flowed out from the second compressor and to be expanded by the expansion mechanism and (ii) the fuel; and
a third heat exchanger that performs a heat exchange between (i) the working fluid extracted from the connecting point and to be compressed by the second compressor and (ii) the fuel,
wherein the fuel
(i) passes through the second heat exchanger first and then passes through the third heat exchanger, or
(ii) passes through the third heat exchanger first and then passes through the second heat exchanger.
